(19) United States
(12) Patent Application Publication
(10) Pub. No.: US 2011/0133424 A1
(43) Pub. Date: Jun. 9, 2011

(54) SUSPENSION APPARATUS FOR VEHICLE

(75) Inventor: Shinya Nishigaya, Aichi-ken (JP)

(73) Assignee: TOYOTA JIDOSHA KABUSHIKI KAISHA, Toyota-shi, Aichi (JP)

(21) Appl. No.: 13/056,870

(22) PCT Filed: May 14, 2010
(86) PCT No.: PCT/JP10/58578

§ 371 Date: Jan. 31, 2011

(30) Foreign Application Priority Data
Jun. 22, 2009 (JP) 2009-147328

(51) Int. Cl. B60G 3/00

(52) U.S. Cl. 280/124.125

(57) ABSTRACT

A suspension apparatus for a vehicle, including: a loop spring that includes a main portion having a shape obtained by forming an elongate member into a loop as seen in a wheel-axis direction in which an axis of a wheel extends and a first and a second attachment portion fixedly provided at one and the other of opposite ends of the main portion and attached to a body of the vehicle so as to be rotatable about respective rotation axes; and a carrier supported by the loop spring for holding the wheel rotatably about the axis thereof, wherein the apparatus is configured to suspend the vehicle body based on an elastic reaction force of the main portion, wherein the apparatus further comprises a plurality of carrier supporting portions each of which is fixedly provided on the loop spring at a circumference thereof, and wherein the carrier is supported by the carrier supporting portions.

### TECHNICAL FIELD

The present invention relates to a suspension apparatus for a vehicle for suspending a body of the vehicle.

### BACKGROUND ART

The inventor of the present invention invented a novel suspension apparatus for a vehicle under original ideas, and the applicant of the present application filed a patent application relating to the invention prior to the present application. The patent application has been published as the Patent Document indicated below. The vehicle suspension apparatus relating to the previously filed patent application includes a loop-like suspension spring as a principal constituent element. The loop spring includes: (A) a main portion having a shape obtained by forming an elongate member into a loop as seen in a wheel-axis direction; (B) a first attachment portion which is fixedly provided at one of opposite ends of the main portion and which is attached to a vehicle body so as to be rotatable about a first rotation axis; and (C) a second attachment portion which is fixedly provided at the other of the opposite ends of the main portion and which is attached to the vehicle body so as to be rotatable about a second rotation axis different from the first rotation axis.

The loop spring of the above-indicated suspension apparatus has a characteristic structure different from those of a coil spring, a leaf spring, an air spring, and the like, known in the art, and the above-indicated suspension apparatus is characterized in that the suspension apparatus does not need a suspension link for defining an orbit or path of an up-down movement of a wheel relative to the vehicle body. Accordingly, the above-indicated suspension apparatus is simple in construction.

Patent Document: JP-A-2008-195352

### DISCLOSURE OF THE INVENTION

### (A) Summary of the Invention

The above-described suspension apparatus is still under development, and there is plenty of room for various improvements, namely, for improving utility. The present invention has been developed in the light of such situations, and it is therefore an object of the invention to provide a suspension apparatus equipped with a loop-like suspension spring that is capable of ensuing high utility.

To achieve the object indicated above, a suspension apparatus for a vehicle according to the present invention includes the loop spring and a carrier which is supported by the loop spring and which holds a wheel rotatably about an axis of the wheel. The suspension apparatus is characterized in that the carrier is supported by the loop spring through a plurality of carrier supporting portions that are fixedly provided on the loop spring at a circumference thereof.

The carrier is supported by the plurality of carrier supporting portions, so that it is possible to realize, with higher stability, a wheel alignment change in an up-down movement of the wheel relative to the vehicle body.

### FORMS OF CLAIMABLE INVENTION

There will be explained various forms of an invention which is considered claimable (hereinafter referred to as “claimable invention” where appropriate). Each of the forms of the invention is numbered like the appended claims and depends from the other form or forms, where appropriate. This is for easier understanding of the claimable invention, and it is to be understood that combinations of constituent elements that constitute the invention are not limited to those described in the following forms. That is, it is to be understood that the claimable invention shall be construed in the light of the following descriptions of various forms and embodiments. It is to be further understood that any form in which one or more elements is/are added to or deleted from any one of the following forms may be considered as one form of the claimable invention.

In the forms indicated below, the form (1) is a form on which the claimable invention is based. The forms which follow the form (1) and which directly or indirectly depend from the form (1) are forms of the claimable invention. In the following forms, a combination of the forms (1) and (2) corresponds to claim 1. A form in which the technical feature of the form (5) is added to claim 1 corresponds to claim 2. A form in which the technical feature of the form (6) is added to claim 2 corresponds to claim 3. A form in which the technical features of the forms (7) and (8) are added to any one of claims 1-3 corresponds to claim 4. A form in which the technical features of the forms (9) and (11) are added to any one of claims 1-4 corresponds to claim 5. A form in which the technical feature of the form (12) is added to any one of claims 1-5 corresponds to claim 6. A form in which the technical features of the forms (14) and (16) are added to any one of claims 1-6 corresponds to claim 7. A form in which the technical features of the forms (17) and (18) are added to any one of claims 1-7 corresponds to claim 8. A form in which the technical feature of the form (20) is added to any one of claims 1-8 corresponds to claim 9. A form in which the technical feature of the form (21) is added to any one of claims 1-9 corresponds to claim 10. A form in which the technical feature of the form (22) is added to any one of claims 1-10 corresponds to claim 11. A form in which the technical feature of the form (24) is added to any one of claims 1-11 corresponds to claim 12. A form in which the technical features of the forms (28) and (29) are added to any one of claims 1-12 corresponds to claim 13. A form in which at least one of the technical feature of the form (31) and the technical feature of the form (34) is added to any one of claims 1-13 corresponds to claim 14. A form in which the technical feature of the form (37) is added to any one of claims 1-14 corresponds to claim 15.

(1) A suspension apparatus for a vehicle, comprising:

a loop spring including: (A) a main portion having a shape obtained by forming an elongate member into a loop as seen in a wheel-axis direction in which an axis of a wheel extends; (B) a first attachment portion which is fixedly provided at one of opposite ends of the main portion and which is attached to a body of the vehicle so as to be rotatable about a first rotation axis; and (C) a second attachment portion which is fixedly provided at the other of the opposite ends of the main portion and which is attached to the body of the vehicle so as to be rotatable about a second rotation axis different from the first rotation axis; and

a carrier which is supported by the loop spring and which holds the wheel rotatably about the axis thereof,

wherein the suspension apparatus is configured to suspend the body of the vehicle based on an elastic reaction force of the main portion of the loop spring.

As explained above, this form relates to a construction on which the claimable invention is based. The loop spring in this form functions as a suspension spring that suspends the vehicle body based on the elastic reaction force of the main portion, and is configured such that an amount of elastic deformation of the main portion of the loop spring changes in association with an up-down movement of the wheel held by the carrier and the elastic reaction force changes based on the change of the elastic deformation amount. When the wheel moves up and down relative to the vehicle body, the loop spring tends to swing about a portion thereof at which the loop spring is attached to the vehicle body. Since the rotation axes of the respective two attachment portions mutually differ, however, the swinging of the loop spring causes a change of at least one of bending deformation and twisting deformation, of the main portion, and the elastic reaction force is changed by the change. Further, the loop spring is supported at the two attachment portions, and the main portion is elastically deformed in accordance with a position of the wheel in the up-down direction with respect to the up-down movement of the wheel relative to the vehicle body. Accordingly, the wheel held by the carrier that is supported by the loop spring swings along a constant orbit or path. Therefore, the loop spring in the suspension apparatus according to this form has not only a function as the suspension spring, but also a function of defining a swing locus of the wheel, namely, a function as a suspension link.

In the present specification, the “axis of an wheel” means a rotation axis of the wheel. The “wheel-axis direction” in which the axis of the wheel extends may be considered to substantially coincide with a width direction of the vehicle where a wheel alignment change is excluded. That is, the wheel-axis direction may be considered as a direction that allows a certain degree of latitude in which the wheel alignment change is taken into account. Accordingly, “as seen in the wheel-axis direction” is generally synonymous with “in side view of the vehicle”. The following explanation will be made based on the premise. It is noted, however, that the wheel-axis direction is strictly interpreted and does not necessarily coincide with the vehicle width direction when focusing on the wheel alignment change.

The main portion of the loop spring needs to have a generally annular shape as seen in the wheel-axis direction. That is, the main portion may be circular or annular with a polygonal shape. Further, the main portion may have a shape in which opposite ends of the main portion are spaced apart from each other, namely, a generally “C” shape. Moreover, the cross-sectional shape of the elongate member by which the main portion is formed may not be particularly limited. It may be possible to employ, as the elongate member, members having various cross-sectional shapes. For instance, there may be employed a solid member such as a round bar or a square bar, a hollow member such as a round pipe or a square pipe, and an oddly shaped member such as a channel. The main portion may be formed by an elongate member having a uniform cross section in its length direction or an elongate member having mutually different cross-sectional shapes at mutually different portions in its length direction. Moreover, the elongate member may be a single member or may be constructed such that a plurality of portions thereof having mutually different cross-sectional shapes are provided by a plurality of mutually different members that are joined or fastened, for instance, as explained below. The material of the elongate member is not particularly limited. The elongate member may be formed of a steel member such as a spring steel or a resin material such as fiber-reinforced plastics (FRP). In this respect, it is not necessarily required that the main portion is formed by curling or bending a straight elongate member. The main portion may be formed by an elongate member originally having a loop-like shape obtained by cutting a plate member or may be formed by connecting a plurality of elongate members each having an arcuate shape.

The two attachment portions fixedly provided at one and the other of the opposite ends of the main portion of the loop spring need to be disposed such that the respective rotation axes thereof are mutually different, and the positional relationship between the two attachment portions is not particularly limited. The positional relationship of the two attachment portions is a concept that includes the disposition relationship of the rotation axes. For instance, the two attachment portions may be disposed such that the respective rotation axes thereof are parallel to each other or such that the respective rotation axes thereof intersect each other. Here, the intersection of the two rotation axes includes a concept of three-dimensional intersection. To be more specific, the loop spring may be constituted such that the two attachment portions overlap each other or deviate from each other in a front-rear direction, an up-down direction, or an oblique direction, as seen in the wheel-axis direction. Further, the loop spring may be constituted such that the two attachment portions are located at the substantially same position in the wheel-axis direction, namely, such that the two attachment portions hardly deviate from each other in the wheel-axis direction, or such that the two attachment portions are located at respective positions that deviate from each other to a certain extent. For permitting the loop spring to have a reduced size, it is desirable that the two attachment portions be located as close as possible to each other. In terms of the swinging of the loop spring caused by the up-down movement of the wheel relative to the vehicle body, it is desirable to dispose the two attachment portions such that the loop spring swings about a swing axis that is as parallel as possible to the wheel axis.

The two attachment portions of the loop spring may be attached to the vehicle body such that each attachment portion is rotatably attached to the vehicle body in a state in which a displacement thereof relative to the vehicle body is prohibited or such that each attachment portion is rotatably attached to the vehicle body in a state in which a certain degree of displacement thereof relative to the vehicle body is allowed. In other words, each attachment portion may be attached in a state in which compliance with respect to the vehicle body is not ensured or in a state in which compliance with respect to the vehicle body is ensured. In short, each attachment portion may be rotatably supported on the vehicle body by a ball bearing, a roller bearing, or the like, or may be supported on the vehicle body by a rubber bushing or the like. It is desirable that at least one of the two attachment portions be attached to the vehicle body in a state in which a displacement thereof in a direction of its rotation axis is prohibited.

The positional relationship of the two attachment portions of the loop spring influences a manner of the elastic deformation of the main portion of the loop spring caused by the swinging of the wheel relative to the vehicle body. For instance, where the two attachment portions are disposed such that the respective rotation axes thereof are parallel to and spaced apart from each other, the elastic deformation of the main portion is mainly the bending deformation. In contrast, where the two attachment portions are disposed such that the two attachment portions overlap each other as seen in the wheel-axis direction and the respective rotation axes thereof intersect each other, the elastic deformation of the main portion includes the twisting deformation. Accordingly, the manner of the elastic deformation of the main portion can be realized variously as the bending deformation, the twisting deformation, or composite deformation in which the bending deformation and the twisting deformation are included at various ratios, by variously changing the positional relationship of the two attachment portions.

The above-indicated elastic deformation of the main portion of the loop spring that is caused by the swinging of the wheel relative to the vehicle body causes a change of the position, in the vehicle width direction, of the carrier supported by the loop spring and a change of the inclination of the carrier relative to a plane perpendicular to the wheel axis. That is, the suspension apparatus according to this form can be constituted such that the alignment of the wheel held by the carrier is changed in association with the swinging of the wheel relative to the vehicle body. In other words, a toe angle of the wheel, a camber angle of the wheel, and so on are changed in a bound movement and a rebound movement, of the wheel and the vehicle body. The change of the wheel alignment can be realized in an arbitrary arrangement by arbitrarily setting the manner of the elastic deformation of the main portion. In the present specification, the “bound movement” means a movement of the wheel and the vehicle body toward each other in the up-down direction while the “rebound movement” means a movement of the wheel and the vehicle body away from each other in the up-down direction. More specifically, the bound movement and the rebound movement not only mean that the wheel and the vehicle body move toward and away from each other from respective positions thereof in a neutral state in which the vehicle is kept stationary on a flat and horizontal road surface, but also broadly mean that the wheel and the vehicle body move toward and away from each other irrespective of at which positions the wheel and the vehicle are located.

The carrier is supported by the loop spring. In this form, the carrier may be supported at one position of the loop spring or at a plurality of positions as explained below. Where the carrier is supported at the plurality of positions, namely, where the carrier is supported at a plurality of carrier supporting portions, the carrier is desirably supported such that at least one of a plurality of carrier-support points which are respectively supported by the plurality of carrier supporting portions is allowed to be displaced to a certain degree. In short, it is desirable to ensure a certain degree of compliance of the carrier with respect to the loop spring so as not to hinder adequate elastic deformation of the main portion of the loop spring, for instance.

(2) The suspension apparatus according to the form (1), further comprising a plurality of carrier supporting portions each of which is fixedly provided on the loop spring at a circumference thereof,

wherein the carrier is supported by the plurality of carrier supporting portions.

As explained above, the wheel alignment can be changed in association with the up-down movement of the wheel relative to the vehicle body in the suspension apparatus according to the above-described form. The change in the wheel alignment can be realized even in an instance where the carrier is supported at one position of the loop spring. However, where a plurality of carrier supporting portions are provided and the carrier is supported at a plurality of positions of the loop spring as described in this form, it is possible to stably realize the wheel alignment change. In an instance where a lateral force externally acts on the wheel, for example, the lateral force comparatively largely influences the change of the wheel alignment where the carrier is supported by one supporting portion. On the contrary, the influence of the lateral force on the change of the wheel alignment is comparatively small where the carrier is supported by the plurality of supporting portions. That is, the rigidity with respect to the lateral force can be enhanced by providing the plurality of supporting portions, thereby realizing a stable wheel alignment change. In terms of enhancement of the rigidity with respect to the lateral force, one of the plurality of carrier supporting portions is preferably provided on either one of the first attachment portion and the second attachment portion.

The main portion of the loop spring displaces in the vehicle width direction in association with the deformation thereof. The displacement amount differs at different positions of the loop spring. According to this form, the carrier supporting portions are provided at the mutually different plurality of positions, thereby making it possible to change the posture of the carrier, namely, the angle of the carrier relative to a line parallel to the vehicle width direction, and to easily change the wheel alignment, by utilizing a difference in the displacement amount among the plurality positions. By variously changing the positions on the loop spring at which the plurality of carrier supporting portions are to be disposed, the arrangement of the wheel alignment change can be easily varied, so that a desired wheel alignment change can be simply realized. Put another way, the degree of design freedom can be increased in designing the suspension apparatus having desired characteristics.

(3) The suspension apparatus according to the form (2), wherein each of the plurality of carrier supporting portions has a bracket whose proximal end portion is fixed to the loop spring, and said each of the plurality of carrier supporting portions is configured to support the carrier at a distal end portion of the bracket.

(4) The suspension apparatus according to the form (3), wherein each of the plurality of carrier supporting portions is configured such that the distal end of the bracket is located inside the loop of the loop spring as seen in the wheel-axis direction.

In the two forms described above, there are added concrete limitations in relation to the structure of each carrier supporting portion. In the latter form, in particular, the carrier is accommodated within the loop of the loop spring in side view of the vehicle, the suspension apparatus that is compact in size can be realized. The latter form is suitable when the loop spring is accommodated within a rim of a wheel body. In the present specification, the “wheel body” is a constituent element of the wheel and is a generally cylindrical member with a bottom. The wheel body has a rim portion and a disc portion and is configured to hold a tire such that the tire is fitted on the outer circumference of the rim portion.

(5) The suspension apparatus according to any one of the forms (2)-(4), comprising three carrier supporting portions as the plurality of carrier supporting portions.

(6) The suspension apparatus according to the form (5), wherein a disposition angle of each of the three carrier supporting portions with respect to a center of the loop of the loop spring is defined as a carrier-supporting-portion disposition angle, and

wherein the three carrier supporting portions are disposed at respective positions such that a difference in the carrier-supporting-portion disposition angle between any two of the three carrier supporting portions is not less than 90°.

According to the former one of the two forms described above, it is possible to realize the above-described stable change of the wheel alignment by a minimum number of the carrier supporting portions. According to the latter form, since the three carrier supporting portions are disposed at the respective positions on the loop spring that are moderately spaced apart from each other, the carrier can be sufficiently stably supported, whereby the wheel alignment change is more stabilized.

(7) The suspension apparatus according to any one of the forms (2)-(6), wherein each of the plurality of carrier supporting portions is configured to support the carrier so as to permit a pivotal movement of the carrier relative to said each of the plurality of carrier supporting portions.

Where the carrier is supported at the plurality of positions of the loop spring and is fixedly supported at each of the plurality of positions, as explained above, there is a possibility that adequate elastic deformation of the main portion of the loop spring in association with the up-down movement of the wheel is hindered. According to this form, the pivotal movement of the carrier is allowed at each of the plurality of carrier supporting portions, thereby ensuring adequate elastic deformation of the main portion to a certain extent. While each of the plurality of carrier supporting portions may be configured so as to allow the pivotal movement of the carrier along one plane, it is desirable that the pivotal movement of the carrier in all directions be allowed by using a ball joint, a bushing having elasticity, or the like.

(8) The suspension apparatus according to any one of the forms (2)-(7),

wherein a center point of a portion of the carrier that is supported by each of the plurality of carrier supporting portions is defined as a carrier-support point, and

wherein one of the plurality of carrier supporting portions supports the carrier so as to prohibit a displacement of the carrier-support point relative to the one of the plurality of carrier supporting portions while each of the remainder of the plurality of carrier supporting portions supports the carrier so as to permit a displacement of the carrier-support point relative to said each of the remainder of the plurality of carrier supporting portions.

Like the above-described form in which each of the plurality of carrier supporting portions supports the carrier so as to permit its pivotal movement, this form ensures, to a certain extent, the adequate elastic deformation of the main portion of the loop spring in association with the up-down movement of the wheel. This form is preferably performed in combination with the above-described form so as not to hinder the adequate elastic deformation of the main portion of the loop spring. For instance, in order to support the carrier while prohibiting the displacement of the carrier-support point, the carrier supporting portion may be constituted by using a ball joint or the like. In order to support the carrier while allowing the displacement of the carrier-support point, each carrier supporting portion may be constituted by using a bearing component having elasticity such as a rubber bushing. In this form, because the displacement of the carrier-support point at the one of the plurality of carrier supporting portions is prohibited, a displacement of the carrier per se in association with the up-down movement of the wheel can be suppressed by an amount corresponding to the prohibited amount of the displacement of the carrier-support point. Thus, this form is effective in terms of realization of an appropriate change of the wheel alignment.

(9) The suspension apparatus according to any one of the forms (2)-(8),

wherein the elongate member by which the main portion of the loop spring is formed is divided into a first section and a second section in a circumferential direction of the loop of the loop spring, and

wherein one of the plurality of carrier supporting portions is disposed at any one of (a) the first section and (b) a boundary between the first section and the second section while each of the remainder of the plurality of carrier supporting portions is disposed at a portion of the loop spring except (a) the first section and (b) the boundary.

The elongate member by which the main portion of the loop spring is formed may be divided into the two sections in the circumferential direction of the loop of the loop spring, and the characteristics, with respect to the elastic deformation, of the respective two sections may be made mutually different, whereby manners of the elastic deformation of the respective two sections caused by the up-down movement of the wheel relative to the vehicle body can be made mutually different. For instance, it is possible to constitute one of the plurality of carrier supporting portions so as to support the carrier mainly based on an elastic reaction force of one of the two sections and to constitute at least one of the remainder of the plurality of carrier supporting portions so as to support the carrier mainly based on an elastic reaction force of the other of the two sections. By the thus constituting the plurality of carrier supporting portions, the change of alignment of the wheel with respect to its up-down movement can be made characteristic.

(10) The suspension apparatus according to the form (9), wherein the first section and the second section have mutually different cross-sectional shapes.

According to this form, the characteristics, with respect to the elastic deformation, of the respective two sections that constitute the main portion of the loop spring, can be made mutually different by a simple technique. For instance, if the two sections are configured to have respective cross-sectional shapes which are mutually different in an aspect ratio that is a ratio between a dimension in an up-down direction and a dimension in a left-right direction, the manners of the elastic deformation of the respective two sections can be made mutually different using the same material for the two sections. Briefly, by making the dimension in the up-down direction larger than the dimension in the left-right direction, for instance, the bending rigidity in the up-down direction can be made higher than that in the left-right direction.

(11) The suspension apparatus according to the form (9), wherein the first section has bending rigidity higher than that of the second section in an instance where the first section and the second section are bent in a vehicle width direction.

Where the two sections that constitute the main portion of the loop spring are configured to have respective different bending rigidity in the vehicle width direction, the displacement degrees of the respective carrier supporting portions in the vehicle width direction caused by the elastic deformation of the main portion can be made mutually different. According to this form, the displacement, in the vehicle width direction, of the above-described one of the carrier supporting portions that is disposed at the first section or at the boundary between the first and second sections can be reduced, and there is established a wheel alignment change that is based mainly on the displacement, in the vehicle width direction, of at least one of the other carrier supporting portions except for the one of the carrier supporting portions, for instance. That is, the wheel alignment can be changed based on the displacement of at least one carrier supporting portion other than a specific carrier supporting portion while permitting the swing locus of the wheel to rely mainly on the up-down movement of the specific carrier supporting portion. In other words, the suspension apparatus of this form can be configured such that the first section of the main portion functions just like a main suspension arm that is a constituent element of the suspension link. It is noted that the bending rigidity in a direction along a plane perpendicular to the vehicle width direction can be increased in addition to the bending rigidity in the vehicle width direction. In this instance, the first section has a higher function as the main suspension arm. Further, in this instance, the function of the suspension spring is exhibited mainly by the second section.

(12) The suspension apparatus according to any one of the forms (2)-(11), wherein one of the plurality of carrier supporting portions serves as an attachment-portion-disposed carrier supporting portion that is disposed on one of the first attachment portion and the second attachment portion.

In this form, when the lateral force acts on the wheel, a part of the lateral force is received by the one of the two attachment portions. Accordingly, this form is effective for increasing the rigidity of the suspension apparatus with respect to the lateral force. Further, when an external force in a front-rear direction (or in a longitudinal direction) of the vehicle, namely, a longitudinal force, acts on the wheel due to acceleration or deceleration of the vehicle, at least a part of the longitudinal force is received by the one of the two attachment portions. Accordingly, this form is effective for increasing the rigidity of the suspension apparatus with respect to the longitudinal force.

According to this form, in an arrangement wherein the main portion of the loop spring is divided into the first section and the second section which differ from each other in the bending rigidity in the vehicle width direction such that the bending rigidity of the first section in the vehicle width direction is made higher and wherein a specific one of the plurality of carrier supporting portions is disposed at the first section or at the boundary between the first and second sections, another one of the plurality of carrier supporting portions can be disposed at one of the two attachment portions on which the first section is provided, for instance. In such an arrangement, the displacements, in the vehicle width direction, of those two carrier supporting portions caused by the swinging of the loop spring can be made small. Accordingly, the arrangement is effective for realizing the swing locus of the wheel that relies on the up-down movement of the specific carrier supporting portion.

(13) The suspension apparatus according to the form (12),

wherein a center point of a portion of the carrier that is supported by each of the plurality of carrier supporting portions is defined as a carrier-support point, and

wherein the one of the first attachment portion and the second attachment portion on which the attachment-portion-disposed carrier supporting portion is disposed, the carrier-support point for the attachment-portion-disposed carrier supporting portion, and the axis of the wheel are arranged so as to be parallel to a horizontal plane, in a state in which the vehicle equipped with the suspension system is kept stationary on a flat and horizontal road surface.

According to this form, a substantial part of the above-described longitudinal force can be received by the one of the two attachment portions when the vehicle is running straight on the flat and horizontal road surface, for instance. On this occasion, there is hardly generated a force to rotate the one of the two attachment portions due to the longitudinal force, so that it is possible to minimize the wheel alignment change during acceleration and deceleration of the vehicle. In short, this form realizes the suspension apparatus with considerably high rigidity with respect to the longitudinal force.

(14) The suspension apparatus according to any one of the forms (1)-(13), wherein the carrier is disposed inside the loop of the loop spring as seen in the wheel-axis direction.

(15) The suspension apparatus according to any one of the forms (1)-(14), wherein the carrier is disposed at a position where a center of the loop of the loop spring and the axis of the wheel coincide with each other as seen in the wheel-axis direction.

In the above two forms, there are added limitations as to the positional relationship between the carrier and the loop spring. These two forms are effective when the loop spring is accommodated in the rim portion of the wheel body.

(16) The suspension apparatus according to any one of the forms (1)-(15), wherein the loop spring is disposed inside a rim portion of a wheel body as seen in the wheel-axis direction.

According to this form, a substantial part of the loop spring can be accommodated in the rim portion of the wheel body, thereby realizing the suspension apparatus which is compact in size.

(17) The suspension apparatus according to any one of the forms (1)-(16), wherein the first rotation axis and the second rotation axis intersect each other.

This form enables the main portion of the loop spring to undergo the twisting deformation in the up-down movement of the wheel relative to the vehicle body, thereby realizing the suspension apparatus configured to suspend the vehicle body by the elastic reaction force that relies on the twisting deformation.

(18) The suspension apparatus according to the form (17), wherein the first rotation axis and the second rotation axis are located on one plane.

According to this form, the elastic deformation of the main portion of the loop spring caused by the up-down movement of the wheel relative to the vehicle body can be mainly composite deformation in which the bending deformation in the vehicle width direction is added to the twisting deformation. That is, in an extreme sense, the suspension apparatus can be configured to suspend the vehicle body by the elastic reaction force that relies on the above-described composite deformation of the main portion. Where the amount of the composite deformation is arranged to change in association with the bound movement and the rebound movement of the wheel and the vehicle body, the loop spring can be designed such that the shape of the loop remains substantially, unchanged as viewed in the wheel-axis direction. This is effective for accommodating the loop spring in the rim portion of the wheel body while maximizing the shape of the loop, namely, maximizing the length of the main portion.

(19) The suspension apparatus according to any one of the forms (1)-(18), wherein the first attachment portion and the second attachment portion are close to each other in the wheel-axis direction.

According to this form, the dimension of the loop spring as measured in the wheel-axis direction cam be made small. Therefore, this form is effective for accommodating a substantially entire part of the loop spring in the rim portion of the wheel body.

(20) The suspension apparatus according to any one of the forms (1)-(19), wherein the first attachment portion and the second attachment portion overlap each other as seen in the wheel-axis direction.

According to this form, the loop spring can be installed at generally one position of the vehicle body, thus contributing to simplification of a structure for installing the loop spring onto the vehicle body.

(21) The suspension apparatus according to any one of the forms (1)-(20), wherein one of the first rotation axis and the second rotation axis is parallel to the axis of the wheel.

This form enables the wheel to swing, in the bound movement and the rebound movement, along one plane perpendicular to the vehicle width direction or a plane which is not so inclined relative to that one plane. This form is particularly suitable in an instance where an intersection angle of the first rotation axis and the second rotation axis is comparatively small. Where the main portion of the loop spring is constituted so as to be divided into a plurality of sections, it is possible to permit the wheel to swing along one plane substantially perpendicular to the wheel axis by increasing the bending rigidity, in the vehicle width direction, of one of the plurality of sections at which is disposed one of the first and second attachment portions whose rotation axis is parallel to the wheel axis, even in an instance where the first rotation axis and the second rotation axis are not parallel to each other.

(22) The suspension apparatus according to any one of the forms (1)-(21), wherein the axis of the wheel and at least one of the first attachment portion and the second attachment portion are arranged so as to be parallel to a horizontal plane, in a state in which the vehicle equipped with the suspension apparatus is kept stationary on a flat and horizontal road surface.

This form is effective particularly in the suspension apparatus configured such that the first attachment portion and the second attachment portion are located at respective positions which are comparatively close to each other in the up-down direction. By employing this form in the thus constructed suspension apparatus, the swing center of the wheel and the wheel axis can be arranged generally along the horizontal plane in the state in which the vehicle is kept stationary on the flat and horizontal road surface, i.e., in a so-called neutral state. This form enables a difference between the characteristic in the bound movement from the neutral state and the characteristic in the rebound movement from the neutral state to be made comparatively small.

(23) The suspension apparatus according to any one of the forms (1)-(22), wherein the first attachment portion and the second attachment portion are attached to the body of the vehicle at respective positions which are located more forward of the vehicle than the axis of the wheel.

According to this form, the center of swinging of the loop spring that is caused by the up-down movement of the wheel can be located more forward of the vehicle than the wheel axis, thereby realizing the suspension apparatus having a characteristic close to that of a suspension apparatus of a trailing arm type.

(24) The suspension apparatus according to any one of the forms (1)-(23), further comprising a spring support member which is fixed to the body of the vehicle and in which there are integrally formed (i) a first support shaft portion defining the first rotation axis and rotatably supporting the first attachment portion and (ii) a second support shaft portion defining the second rotation axis and rotatably supporting the second attachment portion,

wherein the first attachment portion and the second attachment portion are attached to the body of the vehicle via the spring support member.

According to this form, the loop spring can be installed at one position of the vehicle body, thereby simplifying the structure for installing the loop spring onto the vehicle body and improving installation accuracy. This form is particularly suitable in an instance where the first attachment portion and the second attachment portion overlap each other as seen in the wheel-axis direction. To be more specific, the characteristics of the suspension apparatus are influenced by a variation in the intersection angle of the two attachment portions. In particular, the variation largely influences a wheel rate (suspension rate), namely, an amount of change of the elastic reaction force of the loop spring relative to an amount of displacement of the wheel in the up-down direction (a stroke amount). In the light of this, the variation in the intersection angle of the two attachment portions that arises from an installation error can be made small where the two support shaft portions are formed so at to be integral with each other, contributing to a reduction of a variation in the characteristics of the suspension apparatus.

(25) The suspension apparatus according to any one of the forms (1)-(24), wherein the elongate member by which the main portion of the loop spring is formed is divided into a plurality of sections in a circumferential direction of the loop spring.

As explained above, the elongate member by which the main portion of the loop spring is formed may be divided into a plurality of sections in the circumferential direction of the loop, and the respective characteristics, with respect to the elastic deformation, of the plurality of sections may be made mutually different, whereby manners of the elastic deformation of the respective sections caused by the up-down movement of the wheel relative to the vehicle body can be made mutually different. It is further possible to variously change the characteristic of the change of the alignment relative to the up-down movement of the wheel, based on the positional relationship between the plurality of carrier supporting portions and the plurality of sections. According to this form, the wheel alignment change with desired characteristics can be easily realized by arbitrarily determining the above-indicated positional relationship.

(26) The suspension apparatus according to the form (25), wherein the plurality of sections have mutually different cross-sectional shapes.

According to this form, the respective characteristics, with respect to the elastic deformation, of the plurality of sections that constitute the main portion of the loop spring can be made mutually different by a simple technique. For instance, if the plurality of sections are configured to have respective cross-sectional shapes which are mutually different in an aspect ratio that is a ratio between a dimension in an up-down direction and a dimension in a left-right direction, the manners of the elastic deformation of the respective sections can be made mutually different using the same material for the plurality of sections. Briefly, by making the dimension in the up-down direction larger than the dimension in the left-right direction, the bending rigidity in the up-down direction can be made higher than that in the left-right direction.

(27) The suspension apparatus according to the form (25), wherein the plurality of sections have mutually different bending rigidity in an instance where the plurality of sections are bent in a vehicle width direction.

Where the plurality of sections that constitute the main portion of the loop spring are configured to have respective bending rigidity in the vehicle width direction, the displacement degrees of the respective carrier supporting portions in the vehicle width direction caused by the elastic deformation of the main portion can be made mutually different. According to this form, the wheel alignment change with desired characteristics can be easily realized by a simple technique. This form may be modified such that the plurality of sections differ from each other in the bending rigidity in a direction along the plane perpendicular to the vehicle width direction, in addition to the bending rigidity in the vehicle width direction.

(28) The suspension apparatus according to any one of the forms (1)-(27), wherein the carrier supports a motor configured to drive the wheel.

(29) The suspension apparatus according to the form (28), wherein the carrier supports the motor such that the motor is disposed inside the loop of the loop spring as seen in the wheel-axis direction.

According to the above two forms, the motor for driving the wheel is also disposed in the present suspension apparatus. In the former one of the two forms, the drive motor is supported by the carrier, thereby simplifying the structure of a wheel drive system. In the latter form, the drive motor is disposed inside the loop of the loop spring, namely in a so-called dead space, thereby realizing a compact wheel drive system. Where a substantial part of the loop spring is accommodated in the rim portion of the wheel body, at least a part of the motor can be also accommodated in the rim portion. Accordingly, the motor is configured as a so-called in-wheel motor or as a motor similar to the in-wheel motor.

(30) The suspension apparatus according to any one of the forms (1)-(29), further comprising a damper configured to generate a resistance force against a rotary movement of one of the first attachment portion and the second attachment portion.

In this form, there is added a limitation as to the damper as an important constituent element of the suspension apparatus. The damper may be referred to as a shock absorber. The damper in this form is configured to give a resistance against the rotary movement of the one of the two attachment portions, and can be referred to as a so-called rotary damper. Unlike an arrangement in which is employed a cylinder-rod type damper, namely, a cylinder-rod type shock absorber, that is employed in ordinary vehicles, this form realizes the suspension apparatus that is compact in size.

The structure of the damper is not specifically limited in this form. For instance, it is possible to employ a so-called hydraulic vane type damper which has a plurality of working-fluid chambers whose inner volumes change relative to each other in accordance with the rotation of the one of the two attachment portions and which is configured to give a resistance to flows of the working fluid among the plurality of working-fluid chambers. Further, it is possible to employ a so-called hydrodynamic viscosity type damper in which is provided a movable element configured to move in a fluid in accordance with the rotation of the one of the two attachment portions and which is configured to give a resistance to the movement of the movable element based on the viscosity of the fluid.

(31) The suspension apparatus according to any one of the forms (1)-(30), which is configured such that a toe angle of the wheel changes by a change in a posture of the carrier that is caused by a relative movement of the body of the vehicle and the wheel in an up-down direction.

(32) The suspension apparatus according to the form (31), which is for a front wheel and which is configured such that the toe angle of the wheel changes in a direction in which a toe-out tendency increases, in a bound movement of the body of the vehicle and the wheel and such that the toe angle of the wheel changes in a direction in which a toe-in tendency increases, in a rebound movement of the body of the vehicle and the wheel.

(33) The suspension apparatus according to the form (31), which is for a rear wheel and which is configured such that the toe angle of the wheel changes in a direction in which a toe-in tendency increases, in a bound movement of the body of the vehicle and the wheel and such that the toe angle of the wheel changes in a direction in which a toe-out tendency increases, in a rebound movement of the body of the vehicle and the wheel.

Each of the above three forms is characterized in that the toe angle of the wheel changes in the up-down movement of the wheel relative to the vehicle boy. The change of the toe angle of the wheel is the wheel alignment change. In each of the latter two forms, there is added a limitation as to the direction of the change of the toe angle. The vehicle body rolls when the vehicle turns, and the wheel and the vehicle body undergo the bound movement on the outer-wheel side of the vehicle with respect to the turning while the wheel and the vehicle body undergo the rebound movement on the inner-wheel side of the vehicle with respect to the turning. According to the two forms, the vehicle is realized so as to have vehicle turning characteristics with the tendency of understeer.

(34) The suspension apparatus according to any one of the forms (1)-(33), which is configured such that a camber angle of the wheel changes by a change in a posture of the carrier that is caused by a relative movement of the body of the vehicle and the wheel in an up-down direction.

(35) The suspension apparatus according to the form (34), which is for a front wheel and which is configured such that the camber angle of the wheel changes in a direction in which a positive camber tendency increases, in a bound movement of the body of the vehicle and the wheel and such that the camber angle of the wheel changes in a direction in which a negative camber tendency increases, in a rebound movement of the body of the vehicle and the wheel.

(36) The suspension apparatus according to the form (34), which is for a rear wheel and which is configured such that the camber angle of the wheel changes in a direction in which a negative camber tendency increases, in a bound movement of the body of the vehicle and the wheel and such that the camber angle of the wheel changes in a direction in which a positive camber tendency increases, in a rebound movement of the body of the vehicle and the wheel.

Each of the above three forms is characterized in that the camber angle of the wheel changes in the up-down movement of the wheel relative to the vehicle boy. The change of the camber angle of the wheel is the wheel alignment change. In each of the latter two forms, there is added a limitation as to the direction of the change of the camber angle. The vehicle body rolls when the vehicle turns, and the wheel and the vehicle body undergo the bound movement on the outer-wheel side of the vehicle with respect to the turning while the wheel and the vehicle body undergo the rebound movement on the inner-wheel side of the vehicle with respect to the turning. According to the two forms, the vehicle is realized so as to have vehicle turning characteristics with the tendency of understeer. It is desirable to change the toe angle and the camber angle appropriately depending upon individual vehicles in realizing the vehicle turning characteristics with the tendency of understeer. More specifically, it is desirable that an absolute value of a change amount of each of the toe angle and the camber angle is not excessively large and that the change of each of the toe angle and the camber angle is not abrupt.

The “positive camber” means a state in which the upper portion of the wheel is located more outward of the vehicle than the lower portion thereof while the “negative camber” means a state in which the upper portion of the wheel is located more inward of the vehicle than the lower portion thereof. The description that “the camber angle of the wheel changes in a direction in which a positive camber tendency increases” means that the camber angle in the positive camber state becomes larger and that the camber angle in the negative camber state becomes smaller. Similarly, the description that “the camber angle of the wheel changes in a direction in which a negative camber tendency increases” means that the camber angle in the negative camber state becomes larger and that the camber angle in the positive camber state becomes smaller. As for the toe angle, the description that “the toe angle of the wheel changes in a direction in which a toe-in tendency increases” means that the toe angle in the toe-in state becomes larger and that the toe angle in the toe-out state becomes smaller. The description that “the toe angle of the wheel changes in a direction in which a toe-out tendency increases” means that the toe angle in the toe-out state becomes larger and that the toe angle in the toe-in state becomes smaller.

The above three forms relating to the camber angle may be combined with the three forms relating to the toe angle. In other words, the suspension apparatus equipped with the loop spring may be configured such that the toe angle and the camber angle simultaneously change in the up-down movement of the wheel relative to the vehicle body.

(37) The suspension apparatus according to any one of the forms (1)-(36), which is configured such that, where a lateral force acts on the wheel, the main portion of the loop spring is elastically deformed in accordance with a magnitude of the lateral force and the wheel and the body of the vehicle are moved relative to each other in an up-down direction by a reaction force resulting from the elastic deformation.

This form is characterized in that the wheel moves in the up-down direction where a force in the vehicle width direction externally acts on the wheel, namely, where a lateral force acts on the wheel. As explained above, in the suspension apparatus equipped with the loop spring, the alignment of the wheel can be changed relative to the up-down movement of the wheel. Briefly, this form utilizes the phenomenon of the wheel alignment change conversely. For instance, the lateral force acts on the wheel during turning of the vehicle. The main portion of the loop spring changes the amount of the elastic deformation thereof by the wheel alignment change owing to the action of the lateral force. The elastic reaction force of the loop spring changes by the change of the elastic deformation amount, and the wheel and the vehicle body undergo the bound movement or the rebound movement owing to the change of the elastic reaction force.

(38) The suspension apparatus according to the form (37), which is configured such that, where an outward lateral force acts on the wheel, the wheel and the body of the vehicle undergo a bound movement and such that, where an inward lateral force acts on the wheel, the wheel and the body of the vehicle undergo a rebound movement.

In this form, there is further added a limitation as to the direction of the relative movement of the wheel and the vehicle body with respect to the direction of the lateral force. The outward lateral force is a force in a direction to cause the wheel to be moved away from the vehicle body in the vehicle width direction. For instance, the outward lateral force is an external force that acts, during turning of the vehicle, on the inner wheel located on the inner side with respect to turning. On the contrary, the inward lateral force is a force in a direction to cause the wheel to be moved toward the vehicle body in the vehicle width direction. For instance, the inward lateral force is an external force that acts, during turning of the vehicle, on the outer wheel located on the outer side with respect to turning. According to this form, during turning of the vehicle, there is generated a force in a direction to cause the bound movement on the inner-wheel side with respect to turning while there is generated a force in a direction to cause the rebound movement on the outer-wheel side with respect to turning, thereby restraining the roll of the vehicle body that arises from the vehicle turning. In other words, where the suspension apparatus according to this form is installed on each of the left and right sides of the vehicle, a pair of loop springs provided for the left wheel and the right wheel exhibit a function just like a stabilizer (which is also called a torsion bar).

### BRIEF DESCRIPTION OF THE DRAWINGS

FIG. 1 is a perspective of a suspension apparatus equipped with a loop spring according to one embodiment of the claimable invention.

FIG. 2 is a perspective of the suspension apparatus of the embodiment from a different viewpoint.

FIG. 3 is a plan view of the suspension apparatus of the embodiment from which a motor and a brake device are removed.

FIG. 4 is a front view of the suspension apparatus of the embodiment from which the motor and the brake device are removed.

FIG. 5 is a back view of the suspension apparatus of the embodiment from which the motor and the brake device are removed.

FIG. 6 is a side view of the suspension apparatus of the embodiment from which the motor and the brake device are removed.

FIG. 7 is a front view of the loop spring of the suspension apparatus of the embodiment.

FIG. 8 is a cross-sectional view taken along line A-A in FIG. 4.

FIG. 9 is a cross-sectional view taken along line B-B in FIG. 3.

FIG. 10 is a cross-sectional view taken along line C-C in FIG. 3.

FIG. 11 is a perspective view showing a state in which a wheel is installed on the suspension apparatus of the embodiment.

FIG. 12 is a view showing a swinging state of the loop spring caused by an up-down movement of the wheel, in the suspension apparatus of the embodiment.

FIG. 13 is a perspective view showing a suspension apparatus according to a comparative example, which is equipped with a loop spring.

FIG. 14 is a perspective view of the suspension apparatus of the embodiment, for explaining influences of a lateral force and a longitudinal force.

FIG. 15 is a view showing a model of a suspension apparatus for explaining a wheel alignment change in association with the swinging of the loop spring.

FIG. 16 is a graph showing a change of a displacement amount of each of specific portions of the loop spring in a vehicle width direction, in the model of the suspension apparatus.

FIG. 17 is a graph showing one example of characteristics relating to the wheel alignment change in the model of the suspension apparatus.

FIG. 18 is a graph showing changes in a wheel rate when specifications of the loop spring are variously changed in the model of the suspension apparatus.

FIG. 19 is a graph showing a change in an elastic reaction force of the loop spring when a lateral force acts on the wheel in the suspension apparatus having a stabilizer effect.

### BEST MODE FOR CARRYING OUT THE INVENTION

There will be described in detail a suspension apparatus according to one embodiment of the claimable invention and a modified embodiment thereof, referring to the drawings. It is to be understood, however, that the claimable invention is not limited to the details of the following embodiments but may be embodied with various changes and modifications, such as those described in the FORMS OF THE CLAIMABLE INVENTION, which may occur to those skilled in the art.

### 1. Structure of Suspension Apparatus

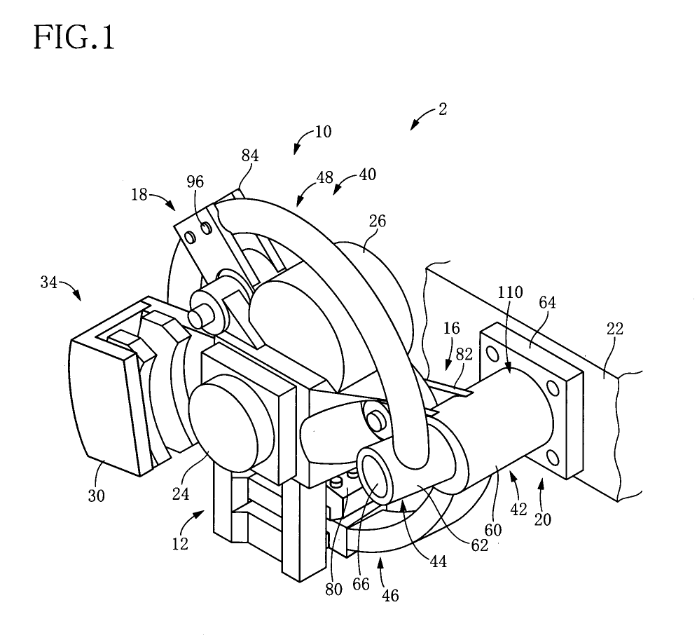

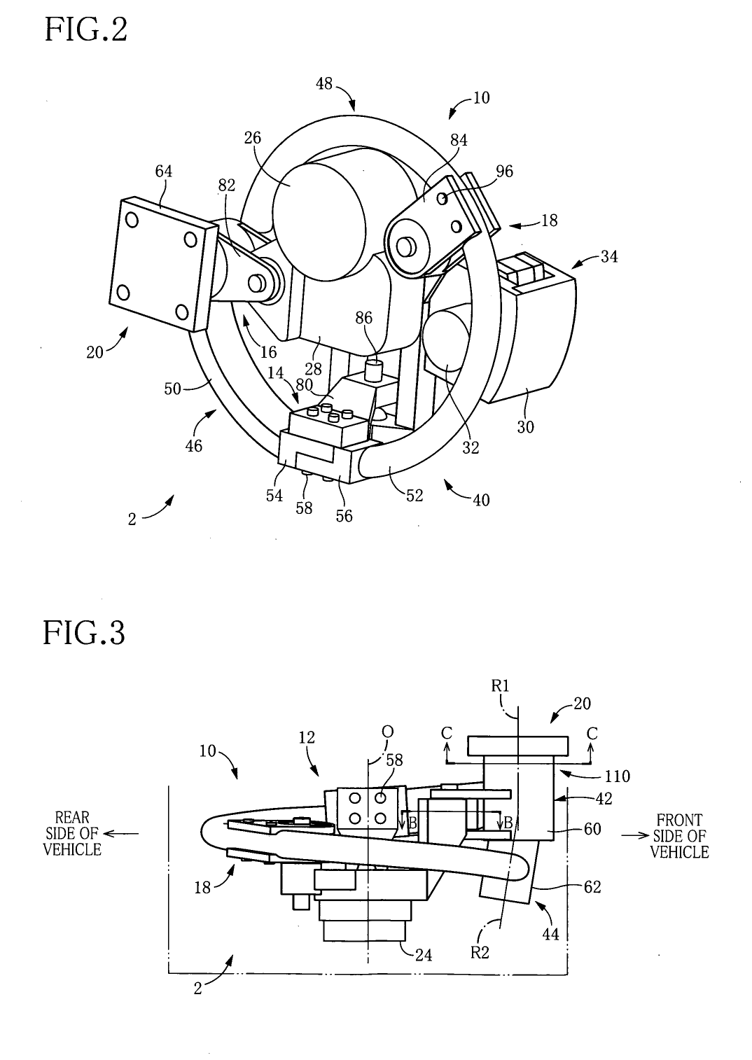

FIGS. 1 and 2 are perspective views each showing a suspension apparatus generally indicated at 2 and constructed according to the embodiment. The suspension apparatus 2 is provided for a rear right wheel of a vehicle and equipped with a loop spring 10 as a main constituent element. The suspension apparatus 2 includes, in addition to the loop spring 10, a carrier 12 for rotatably holding the wheel and three carrier supporting portions through which the carrier 12 is supported by the loop spring 10, i.e., a first carrier supporting portion 14, a second carrier supporting portion 16, and a third carrier supporting portion 18. The loop spring 10 is attached to a side member 22 of a body of the vehicle through a spring support member 20.

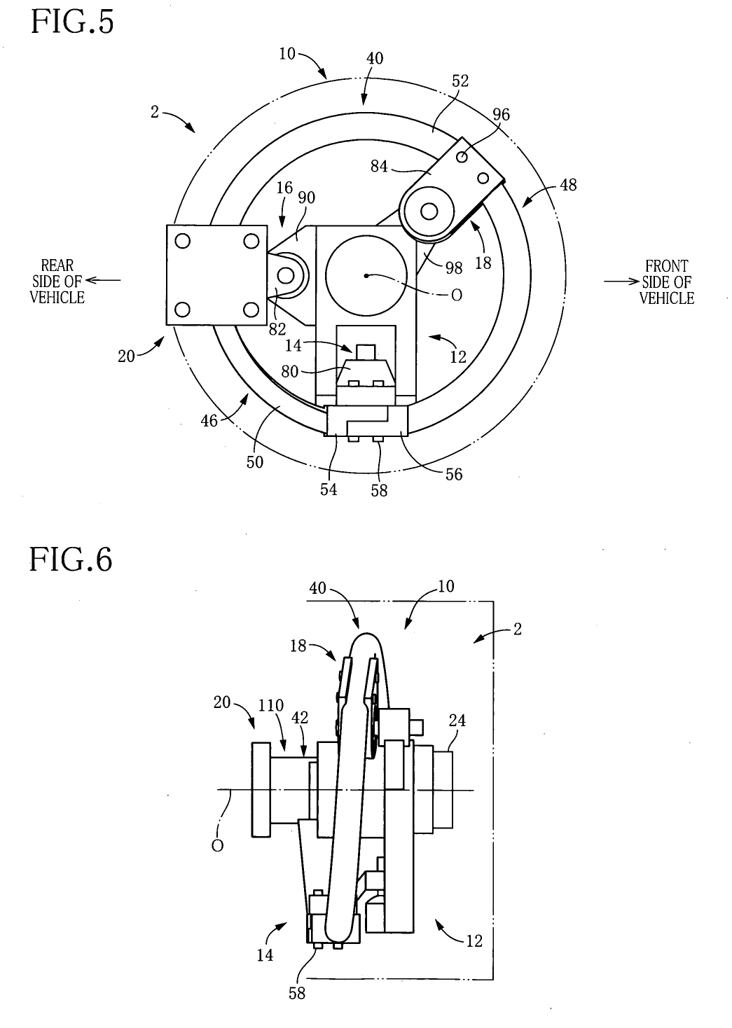

There is rotatably held, on the carrier 12, an axle hub 24 to which a wheel body is attached. There are further held, on the carrier 12, a motor 26 configured to drive the wheel, a decelerator 28 configured to decelerate rotation of the motor 26 for transmission to the axle hub 24, and a brake device 34 including a caliper 30 and a brake cylinder 32. FIGS. 3-6 are a plan view, a front view, a back view, and a side view, respectively, showing the suspension apparatus 2 in a state in which the motor 26, the decelerator 28, and the brake device 34 are removed therefrom. Hereinafter, the structure of the suspension apparatus 2 will be explained in detail with reference to FIGS. 1-6. Each of FIGS. 1-6 shows the suspension apparatus 2 on the assumption that the suspension apparatus 2 is installed on the vehicle and the wheel is attached to the suspension apparatus 2. More specifically, each of FIGS. 1-6 shows the suspension apparatus 2 in a state in which the vehicle is kept stationary on a flat and horizontal road surface, namely, in a state in which the wheel and the vehicle body are not displaced relative to each other in a direction of a bound movement and in a direction of a rebound movement. This state may be hereinafter referred to as a “neutral state” where appropriate.

The loop spring 10 includes a main portion 40 having a shape obtained by forming an elongate member into a loop, a first attachment portion 42 which is fixedly provided at one of opposite ends of the main portion 40 and which is attached to the vehicle body, and a second attachment portion 44 which is fixedly provided at the other of the opposite ends of the main portion 40 and which is attached to the vehicle body. As shown in FIGS. 3-6, where a rotation axis of the wheel held by the carrier 12 is referred to as a wheel axis O, the main portion 40 of the loop spring 10 has a substantially annular shape as seen in a wheel-axis direction in which the wheel axis O extends, namely, in side view of the vehicle. Similarly, the loop of the loop spring 10 has a substantially annular shape. It is noted that the first and second attachment portions 42, 44 are located, in the neutral state, at respective positions which are forwardmost in the loop spring 10 in a front-rear direction of the vehicle.

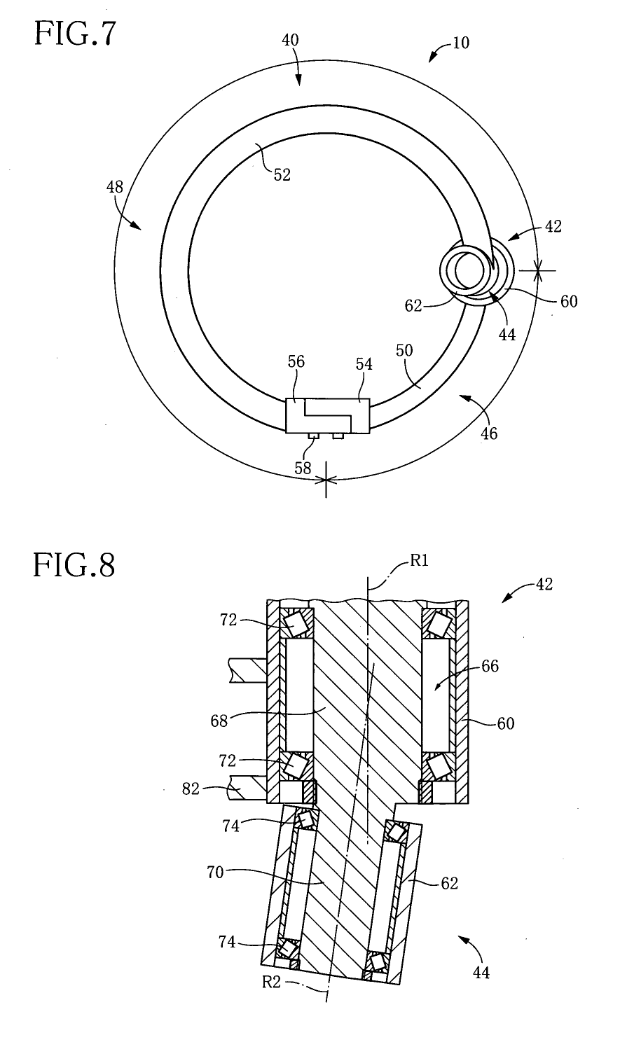

FIG. 7 is a front view of the loop spring 10. As shown in FIG. 7, the main portion 40 is divided into two sections, i.e., a first section 46 and a second section 48. The first section 46 is located at a lower portion of the loop spring 10 nearer to the front side of the vehicle and occupies a region over about one quarter of the length of the loop of the loop spring 10. The second section 48 occupies a region other than the region of the first section 46, namely, a region over about three quarters of the length of the loop of the loop spring 10.

The first section 46 is constituted by a channel member 50 that is formed in an arcuate shape and open upward. The detailed shape of the channel member 50 is not shown in FIG. 7. The second section 48 is constituted by a round pipe member 52 that is formed in an arcuate shape. That is, the first section 46 and the second section 48 have mutually different cross-sectional shapes. Connectors 54, 56 each having a generally L-shaped cross section are fixedly attached to one end of the channel member 50 and one end of the round pipe member 52, respectively. The channel member 50 and the round pipe member 52 are connected to each other such that the connectors 54, 56 are fastened by four bolt and nut pairs 58. The first attachment portion 42 is provided at the other end of the channel member 50 and the second attachment portion 44 is provided at the other end of the round pipe member 52.

In the suspension apparatus 2, the channel member 50 is a steel member having a thickness of about 3 mm, a web width of about 50 mm, and a flange width of about 25 mm while the round pipe member 52 is a steel member having a thickness of about 2 mm and an outside diameter of 40 mm. The diameter of the loop, in other words, the diameter of a neutral axis of the main portion 40, is about 400 mm. Here, the neutral axis may be considered as a line that connects portions of the elongate member at which no stress is generated even in a state in which the elongate member is subjected to bending deformation and twisting deformation. In the suspension apparatus 2, the neutral axis that extends over the entirety of the main portion 40 has a substantially annular shape as seen in the wheel-axis direction.

The first and second attachment portions 42, 44 are constituted principally by a cylindrical member 60 and a cylindrical member 62, respectively. The cylindrical member 60 is joined by welding to the other end of the channel member 50 that constitutes the first section 46 of the main portion 40 while the cylindrical member 62 is joined by welding to the other end of the round pipe member 52 that constitutes the second section 48 of the main portion 40.

The first attachment portion 42 and the second attachment portion 44 are supported by the spring support member 20. Specifically, the spring support member 20 includes a base plate 64 which is fixed to the vehicle body and a shaft 66 which extends from the base plate 64. The first attachment portion 42 and the second attachment portion 44 are rotatably supported by the shaft 66. More specifically, the shaft 66 includes a first support shaft portion 68 located near to the base plate 64 and a second support shaft portion 70 formed integrally with the first support shaft portion 68 at a distal end of the same 68, as shown in FIG. 8. The cylindrical member 60 of the first attachment portion 42 is rotatably supported by the first support shaft portion 68 through roller bearings 72, 72 while the cylindrical member 62 of the second attachment portion 44 is rotatably supported by the second support shaft portion 70 through roller bearings 74, 74.

An axis of the first support shaft portion 68, namely, a first rotation axis R1 which is a rotation axis of the first attachment portion 42 and an axis of the second support shaft portion 70, namely, a second rotation axis R2 which is a rotation axis of the second attachment portion 44 are located on one plane parallel to the horizontal plane, and intersect each other. In this respect, the intersection angle of the rotation axes R1, R2 is about 15°, and the first rotation axis R1 is parallel to the wheel axis O. Moreover, the first attachment portion 42 and the second attachment portion 44 are disposed so as to be close to each other in the wheel-axis direction, and overlap each other as seen in the wheel-axis direction, as apparent from FIG. 3. The first attachment portion 42 is configured to be immovable in a direction of extension of the first rotation axis R1 while the second attachment portion 44 is configured to be immovable in a direction of extension of the second rotation axis R2.

As explained above, in the suspension apparatus 2, the carrier 12 is supported on the loop spring 10 by the first through third carrier supporting portions 14, 16, 18. The first, second, and third carrier supporting portions 14, 16, 18 are constituted mainly by a first bracket 80, a second bracket 82, and a third bracket 84, respectively. Each of the brackets 80, 82, 84 is fixed, at its proximal end portion, to the loop spring 10 and supports, at its distal end portion, the carrier 12. The distal end portion of each of the brackets 80, 82, 84 is located inside the loop of the loop spring 10 as seen in the wheel-axis direction.

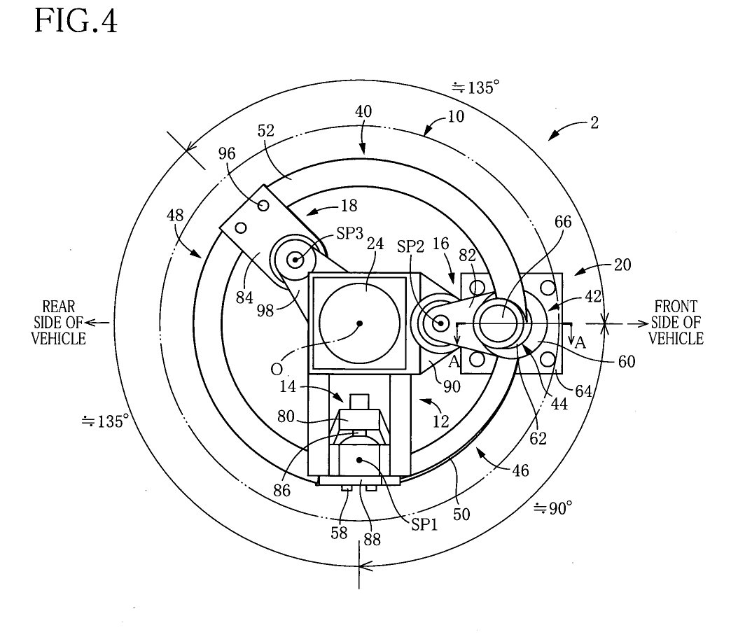

The first carrier supporting portion 14 is disposed at a boundary between the first section 46 and the second section 48 of the loop spring 10. The first bracket 80 that constitutes the first carrier supporting portion 14 is formed by a single member having a stepped shape. The proximal end portion of the first bracket 80 is fixed to the loop spring 10 by being fastened by the four bolt and nut pairs 58, together with the connectors 54, 56 provided on the channel member 50 and the round pipe member 52, respectively. A ball stud 86 is provided at the distal end portion of the first bracket 80. The carrier 12 has, at its lower portion, a socket 88 for holding a ball portion of the ball stud 86. That is, the first carrier supporting portion 14 supports the carrier 12 through the ball joint. Accordingly, the first carrier supporting portion 14 supports the carrier 12 so as to permit a free pivotal movement of the carrier 12 in all directions, relative to itself. Here, where a center point of a portion of the carrier 12 that is supported by the first carrier supporting portion 14 is defined as a first carrier-support point SP1 as shown in FIG. 4, the first carrier supporting portion 14 supports the carrier 12 so as to prohibit a displacement of the first carrier-support point SP1 relative to itself.

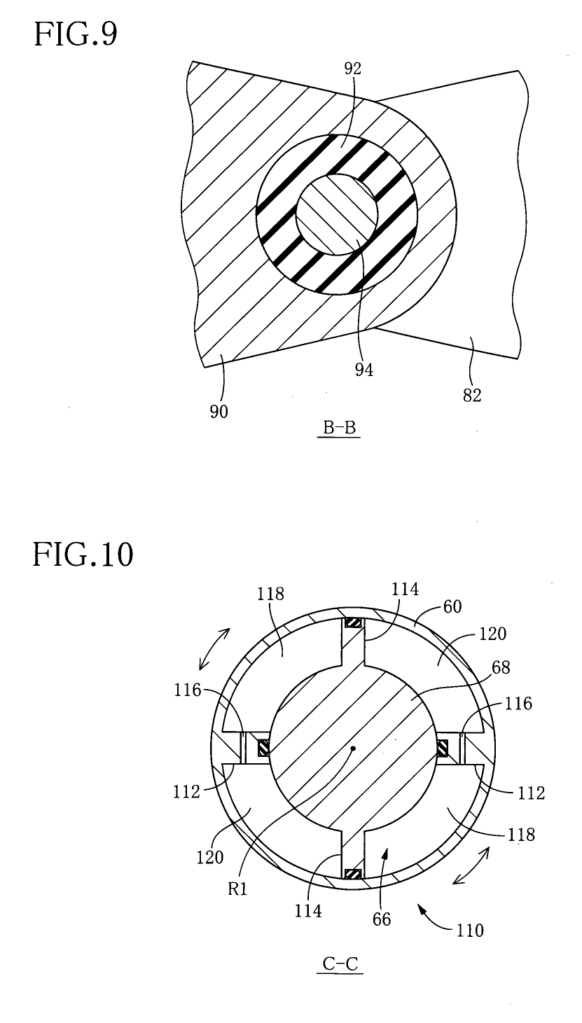

The second carrier supporting portion 16 is disposed on the first attachment portion 42 and serves as an attachment-portion-disposed carrier supporting portion. The second bracket 82 that constitutes the second carrier supporting portion 16 is formed by two plate members which are joined by welding to the cylindrical member 60 that constitutes the first attachment portion 42. The carrier 12 has a supported bracket 90 that is connected, through a rubber bushing 92, to a shaft 94 of the second bracket 82 formed at its distal end portion, as shown in FIG. 9. That is, the second carrier supporting portion 16 supports the carrier 12 through the rubber bushing 92. In this respect, the shaft 94 is substantially parallel to the wheel axis O. Accordingly, the second carrier supporting portion 16 supports the carrier 12 so as to permit a pivotal movement of the carrier 12 relative to itself along a plane perpendicular to the wheel axis O. Here, where a center point of a portion of the carrier 12 that is supported by the second carrier supporting portion 16 is defined as a second carrier-support point SP2 as shown in FIG. 4, the second carrier supporting portion 16 supports the carrier 12 so as to elastically permit a displacement of the second carrier-support point SP2 relative to itself.

The third carrier supporting portion 18 is disposed at a circumferentially intermediate portion of the second section 48 of the loop spring 10. The third bracket 84 that constitutes the third carrier supporting portion 18 is formed by two plate members connected to each other at distal end portions thereof. The third bracket 84 is fastened to the round pipe member 52 of the loop spring 10 by four bolts 96 with the round pipe member 52 sandwiched between proximal end portions of the two plate members. The carrier 12 has a supported bracket 98 that is connected, through a rubber bushing (not shown), to the third bracket 84, in a manner similar to that described above with respect to the second carrier supporting portion 16. That is, the third carrier supporting portion 18 supports the carrier 12 through the rubber bushing. In this respect, the shaft provided at the distal end portion of the third bracket 84 and inserted into the rubber bushing is substantially parallel to the wheel axis O. Accordingly, the third carrier supporting portion 18 supports the carrier 12 so as to permit a pivotal movement of the carrier 12 relative to itself along the plane perpendicular to the wheel axis O. Here, where a center point of a portion of the carrier 12 that is supported by the third carrier supporting portion 18 is defined as a third carrier-support point SP3 as shown in FIG. 4, the third carrier supporting portion 18 supports the carrier 12 so as to elastically permit a displacement of the third carrier-support point SP3 relative to itself.

Here, a disposition angle of each of the three carrier supporting portions 14, 16, 18 with respect to the center of the loop of the loop spring 10 at a time when the suspension apparatus 2 is viewed in the wheel-axis direction is defined as a carrier-supporting-portion disposition angle. The relationship of the positions of the three carrier supporting portions 14, 16, 18 is explained as follows on the basis of the carrier-supporting-portion disposition angles. As shown in FIG. 4, a difference between the disposition angle of the first carrier supporting portion 14 and the disposition angle of the second carrier supporting portion 16 is about 90° while both of a difference between the second carrier supporting portion 16 and the disposition angle of the third carrier supporting portion 18 and a difference between the third carrier supporting portion 18 and the disposition angle of the first carrier supporting portion 14 are about 135°. In other words, the three carrier supporting portions 14, 16, 18 are disposed at the respective positions such that a difference in the carrier-supporting-portion disposition angel between any two of the three carrier supporting portions 14, 16, 18 is not less than 90°.

In the suspension apparatus 2, the carrier 12 supported on the loop sprig 10 through the three carrier supporting portions 14, 16, 18 is disposed substantially inside the loop of the loop spring 10. Further, the carrier 12 is disposed at a position where the wheel axis O coincides with the center of the loop of the loop spring 10 as seen in the wheel-axis direction.

The suspension apparatus 2 further includes a damper 110 constituted by the first attachment portion 42 and one end portion of the shaft 66 of the spring support member 20 nearer to the vehicle body. As shown in FIG. 10, two vanes 112, 112 are formed on an inside of a body-side end portion of the cylindrical member 60 that constitutes the first attachment portion 42, so as to protrude toward the center of the cylindrical member 60, while two vanes 114, 114 are formed at a body-side end portion of the first support shaft portion 68 of the shaft 66, so as to radially protrude. The tip ends of the respective two vanes 112, 112 are in contact with the outer circumferential surface of the first support shaft portion 68 via respective packing members while the tip ends of the two vanes 114, 114 are in contact with the inner circumferential surface of the cylindrical member 60 via respective packing members. In other words, the inside of the body-side end portion of the cylindrical member 60 is divided into four chambers by the vanes 112, 112, 114, 114. The four chambers are filled with a working fluid and function as working-fluid chambers. Each of the two vanes 112, 112 is formed with a communication hole 116. Each of the communication holes 16 allows fluid communication between corresponding adjacent two of the four working-fluid chambers therethrough.

Two of the four working-fluid chambers that are diametrically opposed to each other with the shaft member 66 interposed therebetween are referred to as first working-fluid chambers 118, 118 while the other two of the four working-fluid chambers that are diametrically opposed to each other with the shaft member 66 interposed therebetween are referred to as second working-fluid chambers 120, 120. When the first attachment portion 42 rotates about the first rotation axis R1, one of the volumes of the first working-fluid chambers 118, 118 and the volumes of the second working-fluid chambers 120, 120 increases whereas the other of the volumes of the first working-fluid chambers 118, 118 and the volumes of the second working-fluid chambers 120, 120 decreases. With the volume changes, the working fluid flows from the other of the first working-fluid chambers 118, 118 and the second working-fluid chambers 120, 120 to the one of the first working-fluid chambers 118, 118 and the second working-fluid chambers 120, 120, via the communication holes 116, 116. Each communication hole 116 is configured to give a resistance to a flow of the working fluid that passes therethrough. That is, the communication hole 116 functions as an orifice. Owing to the resistance to the passage of the working fluid, there is given a resistance force, namely, a damping force, to the rotational movement of the first attachment portion 42.

### 2. Principal Functions of Suspension Apparatus

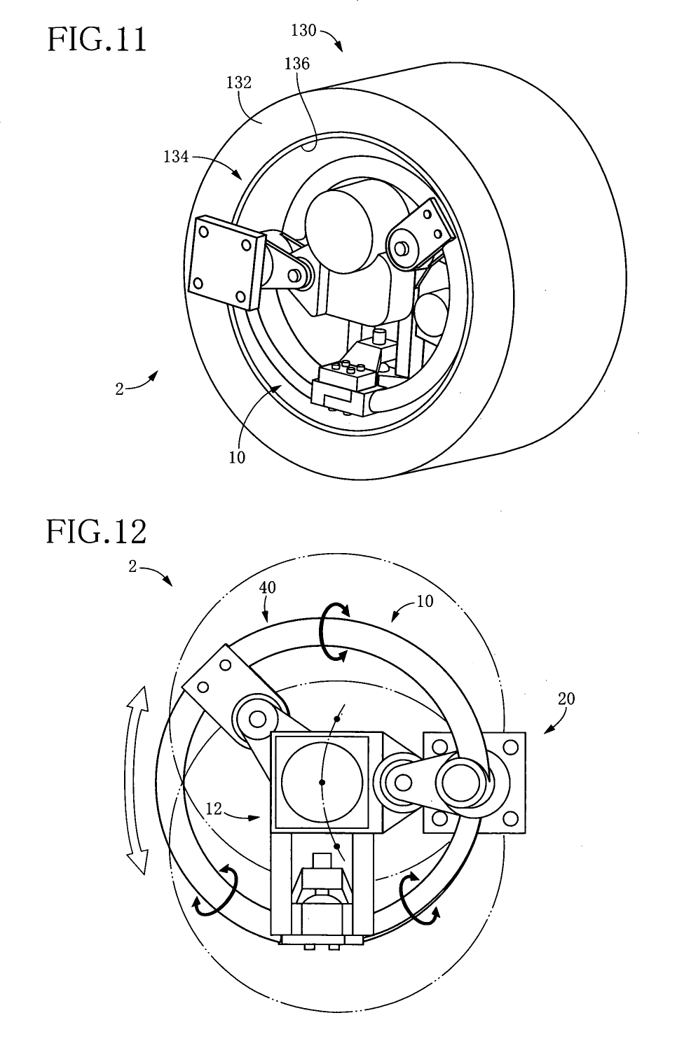

As shown in FIG. 11, a wheel 130 is mounted on the suspension apparatus 2. The wheel 130 is constituted by a tire 132 and a wheel body 134 which holds the tire 132 and which has a generally cylindrical shape with a closed end. The wheel 130 is rotatably held by the carrier 12 such that a disc portion that provides a bottom wall of the wheel body 134 is fastened to the axle hub 24. To the axle hub 24, a brake disc (not shown) is fastened, together with the wheel 130, such that the brake disc is sandwiched by the caliper 30 of the brake device 34.

The inside diameter of a rim portion 136 of the wheel body 134 on which the tire 132 is mounted is about 500 mm, and the loop spring 10 is disposed within the rim portion 136 of the wheel body 134 as seen in the wheel-axis direction. More specifically, a substantially entire portion of the loop spring 10 is accommodated within the rim portion 136, as shown in FIG. 11. In this connection, the two-dot chain line in each of FIGS. 3-6 indicates the inner circumferential surface of the rim portion 136 and the inner surface of the disc portion of the wheel body 134. In a state in which the wheel 130 is mounted, the motor 26 supported by the carrier 12 is also accommodated in the rim portion 136. Accordingly, the motor 26 may be called an in-wheel motor.

As shown in FIG. 12, when the wheel 130 moves upward and downward relative to the vehicle body in the state in which the wheel 130 is mounted, namely, when the wheel 130 and the vehicle body undergo the bound movement or the rebound movement, the loop spring 10 tends to swing about the spring support member 20. On this occasion, the main portion 40 of the loop spring 10 is elastically deformed in accordance with the swinging since the first rotation axis R1 of the first attachment portion 42 and the second rotation axis R2 of the second attachment portion 44 differ from each other. The main portion 40 generates an elastic reaction force based on the elastic deformation. Actually, the suspension apparatus 2 is designed such that the main portion 40 is elastically deformed, in the neutral state, to realize a state in which there is being generated an elastic reaction force that is balanced with a shared load of the vehicle body which is a load the wheel 130 should bear, and each of FIGS. 1-7 shows a state in which the main portion 40 is already elastically deformed. Accordingly, in association with the bound movement and the rebound movement of the wheel 130 and the vehicle body, the amount of the elastic deformation of the main portion 40 changes, and the elastic reaction force changes based on the change of the elastic deformation amount. Thus, the loop spring 10 functions as a suspension spring.

In the suspension apparatus 2, the first attachment portion 42 and the second attachment portion 44 overlap each other as seen in the wheel-axis direction and are disposed close to each other in the wheel-axis direction. More specifically, the rotation axis R1 of the first attachment portion 42 and the rotation axis R2 of the second attachment portion 44 are located on the one plane that is parallel to the horizontal plane and intersect each other. Hence, the elastic deformation of the main portion 40 caused by the swinging of the loop spring 10 is mainly the composite deformation in which the bending deformation in the vehicle width direction is added to the twisting deformation, and the loop spring 10 generates the elastic reaction force mainly based on the composite deformation of the main portion 40. That is, the loop spring 10 is designed such that the main portion 40 hardly undergoes the bending deformation and the shape of the main portion 40 remains substantially unchanged, as viewed in the wheel-axis direction. This fact contributes to maximization of the loop diameter of the loop spring 10, namely, to maximization of the length (the circumferential length, the loop length) of the main portion 40, when the loop spring 10 is disposed in the rim portion 136.

In association with the bound movement and the rebound movement, the loop spring 10 swings along a substantially constant locus. More specifically, since the first rotation axis R1 of the first attachment portion 42 is parallel to the wheel axis O and the second rotation axis R2 of the second attachment portion 44 is inclined by only about 15° relative to the first rotation axis R1, the loop spring 10 swings generally in one plane which is not so inclined relative to the plane perpendicular to the wheel axis O and the wheel 130 held by the carrier 12 swings along a locus that depends on the swing locus of the loop spring 10. Thus, the loop spring 10 has a function of defining a swing locus of the wheel 130, namely, a function as a suspension link. Since the spring support member 20, namely, the first and second attachment portions 42, 44 are located at the respective positions which are located more forward of the vehicle than the wheel axis O, the suspension apparatus 2 has characteristics similar to those of a suspension apparatus of a trailing arm type.

### 3. Compliance Relating to Supporting of Carrier

In the suspension apparatus 2, the carrier 12 is supported by the three carrier supporting portions 14, 16, 18. In general, where the carrier is supported by carrier supporting portions provided at a plurality of locations of the loop spring without particular consideration, appropriate deformation of the main portion of the loop spring in association with the up-down movement of the wheel is hindered due to the rigidity of the carrier supporting portions and the rigidity of the carrier. Accordingly, it is needed to ensure compliance of the loop spring and the carrier to a certain extent.

In the suspension apparatus 2, the elastic deformation of the main portion 40 caused by the swinging of the loop spring 10 is mainly the composite deformation in which the bending deformation in the vehicle width direction is added to the twisting deformation as explained above. This is because the disposition relationship between the first attachment portion 42 and the second attachment portion 44 are determined as described above. By appropriately determining the disposition relationship of the two attachment portions 42, 44, the loop spring 10 is configured such that the main portion 40 hardly undergoes the bending deformation and the shape of the main portion 40 remains substantially unchanged, as viewed in the wheel-axis direction. As a result, the mutual positional relationship of the three carrier supporting portions 14, 16, 18 does not considerably change, as viewed in the wheel-axis direction. This is one feature of the suspension apparatus 2.

On the basis of the above-described feature, the suspension apparatus 2 is configured such that the carrier 12 is supported by the first carrier supporting portion 14 through the ball joint and by the second and third carrier supporting portions 16, 18 through the respective rubber bushings. In short, a sufficient degree of compliance is ensured between the carrier 12 and the loop spring 10 merely by permitting the pivotal movement of the carrier 12 at least about the wheel axis O at the three carrier supporting portions 14, 16, 18 and by permitting the displacements of the respective carrier-support points at the two carrier supporting portions 16, 18.

In the suspension apparatus 2, the bending rigidity in the vehicle width direction and the bending rigidity in a direction along the plane perpendicular to the vehicle width direction are made higher in the first section 46 of the loop spring 10 than in the second section 48. Accordingly, the shared load of the vehicle body and the lateral force that acts on the wheel are received mainly by the first carrier supporting portion 14. This is the reason why the ball joint is used in the first carrier supporting portion 14. In the meantime, the longitudinal force that acts on the wheel is received mainly by the second carrier supporting portion 16 as explained below in detail. In the light of this, the rubber bushing 92 is used in the second carrier supporting portion 16 to ensure appropriate compliance in the longitudinal direction between the carrier 12 and the loop spring 10. Further, as explained below, the stabilizer effect, the characteristic of the wheel alignment change, etc., mainly depend on the structure, the location, etc., of the third carrier supporting portion 18. In the light of this, the rubber bushing is used in the third carrier supporting portion 18.

### 4. Influences of Lateral Force and Longitudinal Force Acting on Wheel

During running of the vehicle, the force in the vehicle width direction, i.e., the lateral force, acts on the wheel due to turning of the vehicle, for instance. Further, during running of the wheel, the force in the longitudinal direction (the front-rear direction) of the vehicle, i.e., the longitudinal force, acts on the wheel due to acceleration and deceleration of the vehicle, for instance. Due to the lateral force and the longitudinal force that act on the wheel, the main portion of the loop spring is deformed, and the alignment of the wheel changes.

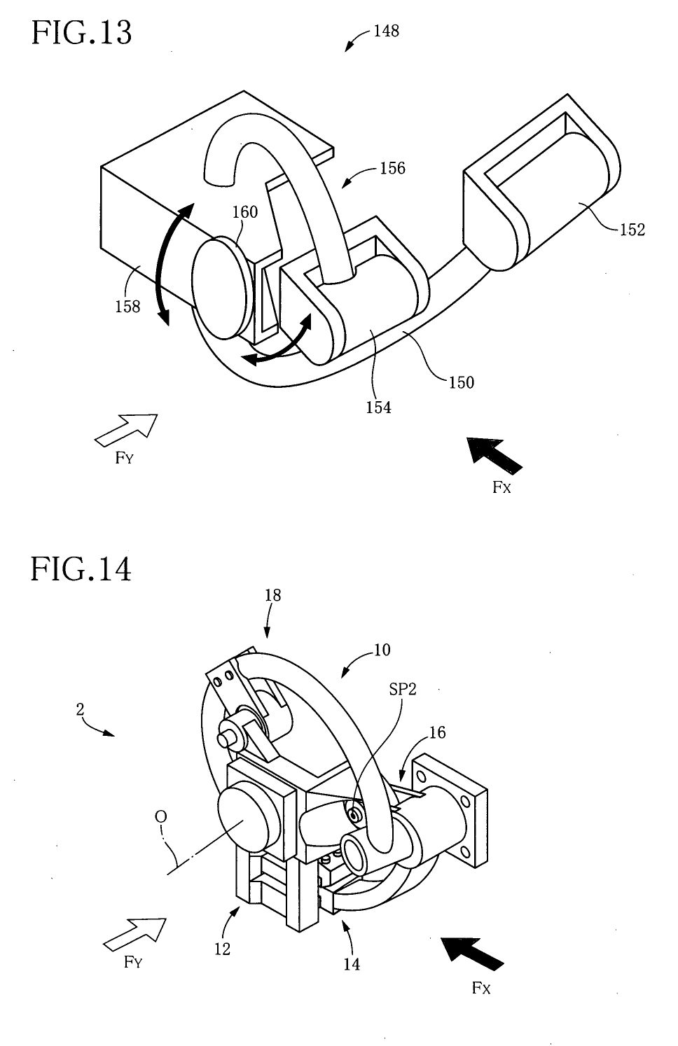

For comparison with the suspension apparatus 2, a suspension apparatus 148 shown in FIG. 13 having a structure different from that of the suspension apparatus 2 is considered. The suspension apparatus 148 includes a loop spring 156 constituted by: a main portion 150 having a shape obtained by forming an elongate member into a loop; and a first attachment portion 152 and a second attachment portion 154 provided on one and the other of opposite ends of the main portion 150. In the suspension apparatus 148, a carrier 158 is fixedly disposed at only one part of the main portion 150 that is the most distant, in the main portion 150, from the first attachment portion 152 and the second attachment portion 154. An axle hub 160 is rotatably held by the carrier 158 at a portion thereof located at nearly the center of the loop of the loop spring 156. In the thus constructed suspension apparatus 148, it can be considered that the carrier 158 is supported by a single carrier supporting portion disposed at one location of the main portion 150.

As shown in FIG. 13, in the above-indicated suspension apparatus 148, the main portion 150 is easily deformed when the lateral force F_{Y} and the longitudinal force F_{X} act on the wheel because the carrier 158 is supported only at the one location of the main portion 150, so that the carrier 158 easily pivots about the longitudinal axis and the lateral axis of the vehicle. That is, the suspension apparatus 148 has a characteristic that the wheel alignment tends to be easily influenced by the lateral force F_{Y} and the longitudinal force F_{X} that act on the wheel. In other words, the rigidity with respect to the lateral force F_{Y} and the longitudinal force F_{X} is comparatively low in the suspension apparatus 148.

In the suspension apparatus 2 according to the present embodiment, in contrast, the carrier 12 is supported by the three carrier supporting portions 14, 16, 18, and the three carrier supporting portions 14, 16, 18 are disposed at the respective positions such that a difference in the carrier-supporting-portion disposition angle between any two of the three carrier supporting portions 14, 16, 18 is not less than 90°. According to the arrangement, the carrier 12 does not easily pivot about the longitudinal axis and the lateral axis of the vehicle by the lateral force F_{Y} and the longitudinal force F_{X}. That is, the suspension apparatus 2 has a characteristic that the wheel alignment is hard to be influenced by the lateral force F_{Y} and the longitudinal force F_{X} that act on the wheel. In other words, the rigidity with respect to the lateral force F_{Y} and the longitudinal force F_{X} is made comparatively high in the suspension apparatus 2.

More specifically, the second carrier supporting portion 16 is provided on the first attachment portion 42 in the suspension apparatus 2. Accordingly, where the lateral force F_{Y} acts on the wheel, the first attachment portion 42 receives a part of the lateral force because the first attachment portion 42 can be regarded as a rigid body and the above-indicated part of the lateral force F_{Y} that the first attachment portion 42 receives does not cause the elastic deformation of the main portion 40 of the loop spring 10. This fact considerably contributes to an increase in the rigidity with respect to the lateral force F_{Y}.

Further, the arrangement in which the second carrier supporting portion 16 is provided on the first attachment portion 42 also contributes to an increase in the rigidity with respect to the longitudinal force F_{X} because the first attachment portion 42 receives a part of the longitudinal force F_{X}, as in the above-described case relating to the lateral force F_{Y}. In the suspension apparatus 2, in particular, the wheel axis O, the second carrier-support point SP2 for the second carrier supporting portion 16, and the first attachment portion 42 are arranged so as to be parallel to the horizontal plane, in the neutral state, as shown in FIG. 4. Hence, it can be considered that, in most cases, the first attachment portion 42 receives a substantial part of the longitudinal force F_{X}, and the rigidity with respect to the longitudinal force F_{X} is made considerably high.

### 5. Wheel Alignment Change in Up-Down Movement of Wheel

In association with the up-down movement of the wheel, the main portion 40 of the loop spring 10 undergoes the twisting deformation and the bending deformation in the vehicle width direction, as explained above. The bending deformation in the vehicle width direction emerges as displacements, in the vehicle width direction, of various portions of the loop spring 10. In the suspension apparatus 2, the carrier 12 is supported at the plurality of portions of the loop spring 10 by the three carrier supporting portions 14, 16, 18. Accordingly, the carrier 12 inclines in a specific direction and at a specific angle relative to the plane perpendicular to the vehicle width direction, on the basis of a difference in displacements (a relative displacement difference) among the respective portions of the loop spring 10 corresponding to the locations of the respective three carrier supporting portions 14, 16, 18. The inclination direction and the inclination angle of the carrier 12 relative to the plane perpendicular to the vehicle width direction change as a result of a change in the above-indicated relative displacement difference among the portions of the loop spring 10 at which the three carrier supporting portions 14, 16, 18 are respectively disposed, in association with the up-down movement of the wheel. That is, in the suspension apparatus 2, the alignment of the wheel such as a toe angle of the wheel, a camber angle of the wheel, etc., changes in association with the up-down movement of the wheel.

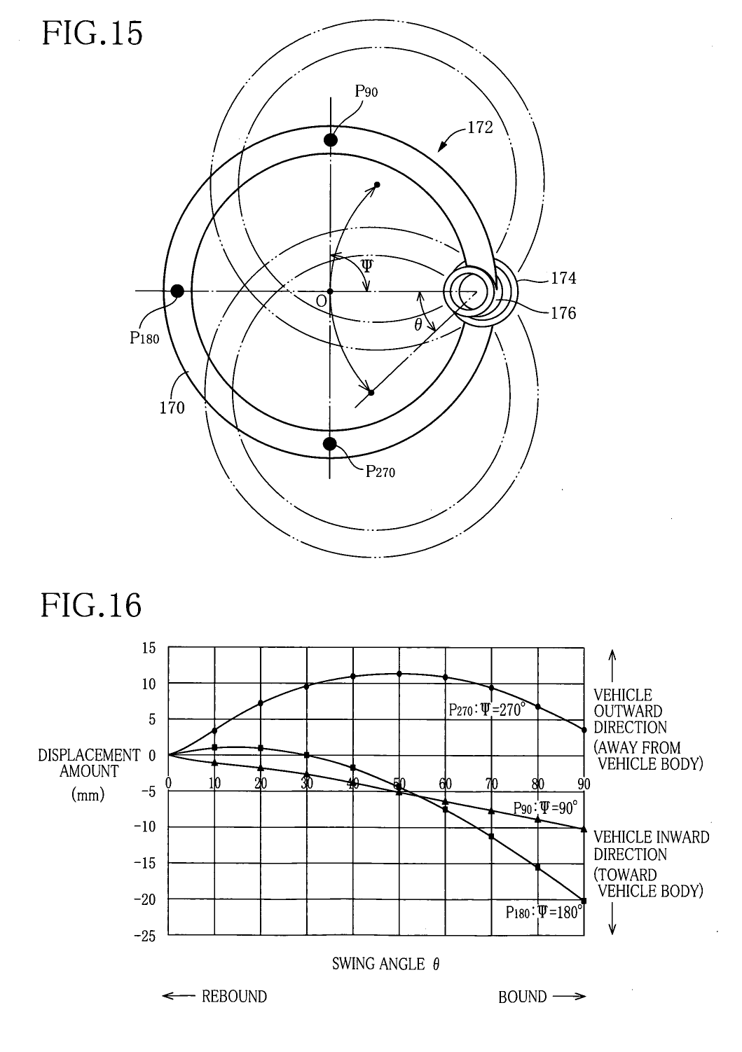

Next, consideration will be made on a suspension apparatus as a model (hereinafter referred to as a “suspension-apparatus model” where appropriate) in relation to the wheel alignment change. As shown in FIG. 15, the suspension-apparatus model employs a loop spring 172 having a main portion 170 formed by a single round pipe member. The loop spring 172 has, as a whole, specifications (such as the dimension and the shape) similar to those of the loop spring 10 described above. Like the suspension apparatus 2, the suspension-apparatus model is for a rear right wheel, and the positional relationship of a first attachment portion 174 and a second attachment portion 174 of the loop spring 172 (including the positional relationship of the rotation axes thereof) is similar to that in the suspension apparatus 2. The loop spring 172 is located at a position where the swing angle θ is equal to 0° in a state in which the loop spring 172 is not elastically deformed. The amount of the elastic deformation of the main portion 170 increases with an increase in the swing angle θ from 0°, and the neutral state is established at a position where the swing angle θ is equal to 45°. With a further increase in the swing angle θ from 45°, the loop spring 172 reaches a position where the swing angle θ is equal to 90°. That is, the direction in which the swing angle θ becomes close to 0° is a direction of the rebound movement while the direction in which the swing angle θ becomes close to 90° is a direction of the bound movement. It is noted that the neutral state indicated by the solid line in FIG. 15 is the position where the swing angle θ is about 45°.

In a state in which the swing angle θ of the loop spring 172 changes as described above, the displacement amounts in the vehicle width direction of respective specific portions P₉₀, P₁₈₀, P₂₇₀ of the loop spring 172 change as indicated in the graph of FIG. 16, with respect to the change in the swing angle θ. As shown in FIG. 15, the specific portions P₉₀, P₁₈₀, P₂₇₀ are located at positions corresponding to respective disposition angles w of 90°, 180°, 270° each represented as a counterclockwise angle around the wheel axis O as the center, in the neutral state, as seen in the wheel-axis direction. In this regard, the position corresponding to the disposition angle Ψ of 0° is a position at which the two attachment portions 174, 176 are present. The displacement amount at each of the specific portions P₉₀, P₁₈₀, P₂₇₀ is a displacement amount from a state in which the swing angle θ is equal to 0°. Where the value of the displacement amount is positive, it means that each specific portion displaced in an outward direction of the vehicle, namely, away from the vehicle body. On the other hand, where the value of the displacement amount is negative, it means that each specific portion displaced in an inward direction of the vehicle, namely, toward the vehicle body.

As apparent from the graph of FIG. 16, the specific portion P₉₀ corresponding to the position where the disposition angle Ψ is equal to 90° displaces gradually so as to approach the vehicle body with an increase in the swing angle θ. The specific portion P₁₈₀ corresponding to the position where the disposition angle w is equal to 180° once displaces slightly so as to be away from the vehicle body and thereafter displaces so as to approach the vehicle body at a gradient larger than that at which the specific portion P₉₀ displaces so as to approach the vehicle body, with an increase in the swing angle θ. The specific portion P₂₇₀ corresponding to the position where the disposition angle Ψ is equal to 270° first displaces so as to be away from the vehicle body at a comparatively large gradient and then displaces so as to approach the vehicle body after the swing angle θ exceeds 50°.

Where the carrier supporting portions are provided at the plurality of portions of the loop spring 172, the inclination direction and the inclination angle of the carrier relative to the plane perpendicular to the vehicle width direction are determined by a difference in the displacement amount among the plurality of portions. By arbitrarily determining the portions on the circumference of the loop of the loop spring 172 where the carrier supporting portions are to be provided, it is possible to realize, with an arbitrary arrangement, the changes of the inclination angle and the inclination amount of the wheel axis O with respect to the swinging of the loop spring 172, namely, the wheel alignment change. To be more specific, it is possible to realize, with an arbitrary arrangement, a change of the toe angle of the wheel and a change of the camber angle of the wheel.

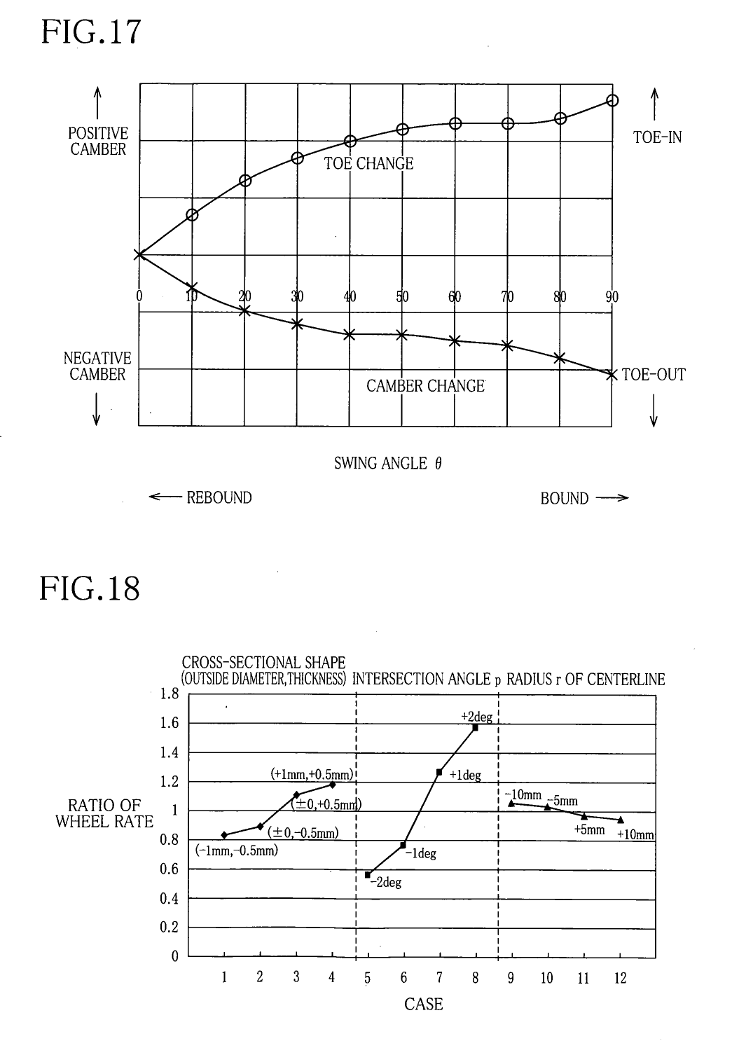

FIG. 17 is a graph showing a change of the toe angle and a change of the camber angle where the three carrier supporting portions are disposed at respective specific positions. The up-down direction in the graph shows a tendency of the toe angle and a tendency of the camber angle. When each of the lines respectively showing the toe change and the camber change is located on the upper side in the graph, it means that the toe-in tendency is high and the positive camber tendency is high. On the contrary, when each of the lines respectively showing the toe change and the camber change is located on the lower side in the graph, it means that the toe-out tendency is high and the negative camber tendency is high. In this regard, FIG. 17 shows characteristics in which the toe angle changes in a direction toward more toe-in tendency and the camber angle changes in a direction toward more negative camber tendency, by the bound movement. Put another way, FIG. 17 shows characteristics in which the toe angle changes in a direction toward more toe-out tendency and the camber angle changes in a direction toward more positive camber tendency, by the rebound movement. By the thus appropriately determining the positions where the three carrier supporting portions are to be disposed, it is possible to realize the wheel alignment change in which desired change characteristics are ensured.

The vehicle body rolls when the vehicle turns, and the wheel and the vehicle body undergo, from the neutral state, the bound movement on the outer-wheel side with respect to the turning while the wheel and the vehicle body undergo, from the neutral state, the rebound movement on the inner-wheel side with respect to the turning. Accordingly, where the suspension apparatus is provided for the rear wheel, the vehicle is realized so as to have turning characteristics with the tendency of understeer by configuring the suspension apparatus such that at least one of the toe angle and the camber angle changes as shown in FIG. 17. On the contrary, where the suspension apparatus is provided for the front wheel, the vehicle is realized so as to have turning characteristics with the tendency of understeer by configuring the suspension apparatus such that at least one of the toe angle and the camber angle changes in a specific manner. That is, where the suspension apparatus is provided for the front wheel, the suspension apparatus may be configured such that the toe angle changes in a direction toward more toe-out tendency by the bound movement and in a direction toward more toe-in tendency by the rebound movement while the camber angle changes in a direction toward more positive camber tendency by the bound movement and in a direction toward more negative camber tendency by the rebound movement.

In the suspension-apparatus model described above, it is regarded, for the sake of brevity, that the wheel alignment changes mainly based on the bending deformation of the main portion 170 of the loop spring 172 in the vehicle width direction caused by the up-down movement of the wheel, namely, based on the displacement of each of the specific portions of the loop spring 172 in the vehicle width direction. The change of the wheel alignment, however, relies also on the twisting deformation of the main portion 170 caused by the up-down movement of the wheel. To be more specific, the inclination angle of each carrier supporting portion relative to the plane perpendicular to the vehicle width direction varies depending upon the twisting direction and the twisting deformation amount of the main portion 170 at each of the portions where the respective carrier supporting portions are disposed. Due to the change of the inclination angle of each carrier supporting portion, the portion of the carrier, i.e., the carrier-support point, at which the carrier is supported by the carrier supporting portion, displaces in the vehicle width direction. On the other hand, the twisting direction and the twisting deformation amount of the main portion 170 differ among the specific portions of the loop spring 172. Accordingly, by appropriately determining the positions where the plurality of carrier supporting portions are to be disposed, it is possible to realize the wheel alignment change in which the desired characteristics are ensured, also based on the twisting deformation of the main portion. It is desirable to determine the positions where the plurality of carrier supporting portions are to be disposed by considering both of the direction and the amount of the displacement in the vehicle width direction of each of the specific portions of the loop spring 172; and the twisting direction and the twisting deformation amount of each of the specific portions.

In the suspension apparatus 2 according to the present embodiment, for realizing the wheel alignment change in which the desired characteristics are ensured, it is needed in principle to determine the positions where the three carrier supporting portions 14, 16, 18 are to be disposed, according to the determination technique of determining the positions of the carrier supporting portions in the above-described suspension-apparatus model. In the suspension apparatus 2, however, the main portion 40 of the loop spring 10 is divided into the two sections 46, 48 having mutually different cross-sectional shapes and bending rigidity values in the vehicle width direction as described above. More specifically, the first section 46 is formed by the channel member 50 while the second section 48 is formed by the round pipe member 52, and the bending rigidity of the first section 46 in the vehicle width direction is made higher than that of the second section 48. Accordingly, it is preferable to determine the positions of the respective three carrier supporting portions 14, 16, 18 also taking this into account. It is possible to realize the wheel alignment change in which the desired change characteristics are ensured by arbitrarily determining not only the positions of the three carrier supporting portions 14, 16, 18, but also the disposition relationship between the first attachment portion 42 and the second attachment portion 44 such as the intersection angle of the first and second rotation axes R1, R2, the cross-sectional shape of the elongate member by which the main portion 40 of the loop spring 10 is formed, absolute values of modulus of longitudinal elasticity and modulus of transverse elasticity of the elongate member and a ratio thereof, the dimensions of the brackets 80, 82, 84 that constitute the respective three carrier supporting portions 14, 16, 18, and so on.

It is a prerequisite in the suspension apparatus 2 that the first carrier supporting portion 14 is disposed at the boundary between the first section 46 and the second section 48 and that the second carrier supporting portion 16 is disposed at the first attachment portion 42. The second carrier supporting portion 16 does not displace in the vehicle width direction, irrespective of the swing position of the loop spring 10. Further, the bending rigidity of the first section 46 in the vehicle width direction is high. Accordingly, the displacement of the first carrier supporting portion 14 in the vehicle width direction caused by the swinging of the loop spring 10 is comparatively small. Hence, the first carrier supporting portion 14 swings generally in one plane perpendicular to the vehicle width direction, and the carrier 12 swings along a locus that is not so inclined relative to the one plane. In the light of this, it can be considered that the first section 46 functions just like a main suspension arm while the second section 48 functions just like a toe control arm in a multi-link type suspension apparatus, namely, a suspension arm for changing at least one of the toe angle and the camber angle of the wheel.

In view of the above, in the suspension apparatus 2, it is possible to adjust the toe angle and the camber angle of the wheel and the characteristics of the wheel alignment change, in the neutral state, by mainly adjusting the position of the third carrier supporting portion 18 disposed between the opposite ends of the second section 48 of the main portion 40. In the suspension apparatus 2, the third bracket 84 that constitutes the third carrier supporting portion 18 is fixed to the second section 48 by being fastened with the four bolts 96 for enabling the adjustment of the position of the third carrier supporting portion 18. By loosening the four bolts 96, it is possible to easily adjust the position of the third bracket 84, namely, the disposition angle explained above. In the suspension apparatus 2, the toe angle and the camber angle of the wheel and the characteristics of the wheel alignment change, in the neutral state, can be easily adjusted by adjusting only one of the three carrier supporting portions 14 16, 18.

### 6. Characteristic Differences by Changes of Specifications of Loop Spring

The characteristics of the suspension apparatus can be changed by changing the specifications of the loop spring such as the dimension, the shape, and the member to be employed. A wheel rate (suspension rate) is one representative characteristic of the suspension apparatus. The wheel rate can be regarded as a rate of the component of the elastic reaction force in the up-down direction with respect to the swing angle of the lop spring, namely, as one sort of a spring constant, for instance. The following are examination results as to how the wheel rate changes with changes in the specifications of the loop spring 172 in the suspension-apparatus model described above.

The loop spring 172 shown in FIG. 15 is set as a reference spring having nominal or basic specifications. For the reference spring, there were examined: (A) cases in each of which the cross-sectional shape, i.e., the outside diameter and the thickness, of the main portion 170 were changed; (B) cases in each of which the intersection angle of the rotation axis of the first attachment portion 174 and the rotation axis of the second attachment portion 176 was changed; and (C) cases in each of which the radius r of the neutral axis of the loop spring 172 was changed. In each of the cases described above, the wheel rate of the loop spring 172 was calculated and compared with the wheel rate of the reference spring. A ratio of the wheel rate of the loop sprig 172 in each case with respect to the wheel rate of the reference spring is shown in FIG. 18. In the graph of FIG. 18, the cases 1-4 correspond to the cases (A) in each of which the cross-sectional shape of the main portion 170 was changed, the cases 5-8 correspond to the cases (B) in each of which the intersection angle p was changed, and the cases 9-12 correspond to the cases (C) in each of which the radius r of the neutral axis was changed.

As apparent from the graph of FIG. 18, the wheel rate increases with increases in the outside diameter and the thickness in the cross-sectional shape of the main portion 170 of the loop spring 172 and decreases with decreases in the outside diameter and the thickness. Further, the wheel rate increases with an increase in the intersection angle p of the rotation axes of the two attachment portions 174, 176 and decreases with a decrease in the intersection angle p. Moreover, the wheel rate decreases with an increase in the radius r of the neutral axis of the loop spring 172 and increases with a decrease in the radius r. It is also apparent from the graph of FIG. 18 that the wheel rate changes more largely where the intersection angle p of the rotation axes was changed than where the cross-sectional shape of the loop spring was changed and where the radius r of the neutral axis was changed. In other words, the change of the wheel rate is sensitive to the intersection angle p of the rotation axes of the two attachment portions 174, 176.

In view of the above, the suspension apparatus 2 according to the present embodiment is configured such that the loop spring 10 is supported by the single spring support member 20 shown in FIG. 8. To be more specific, in the shaft 66 of the spring support member 20, the first support shaft portion 68 for rotatably supporting the first attachment portion 42 and the second support shaft portion 70 for rotatably supporting the second attachment portion 44 are formed integrally with each other, whereby it is possible to reduce variations in the intersection angle of the rotation axes of the two attachment portions 174, 176. Consequently, the characteristics of the suspension apparatus can be prevented from largely deviating from the desired characteristics and it is possible to reduce nonuniformity in the characteristics among suspension apparatuses of individual vehicles. For fabricating the shaft 66 in which the first support shaft portion 68 and the second support shaft portion 70 are integral with each other, the shaft 66 may be formed by a single member by machining, for instance.

### 7. Stabilizer Effect

As explained above with respect to the suspension-apparatus model, the main portion of the loop spring is elastically deformed in accordance with a change in the swing angle θ of the loop spring, and the elastic reaction force of the loop spring changes in accordance with the elastic deformation, so that the alignment of the wheel changes. Conversely, this means that where an external force that changes the alignment of the wheel acts on the wheel, the elastic deformation amount of the main portion changes in accordance with the external force. The elastic reaction force of the loop spring can be divided into a component that shares the load of the vehicle body, namely, an up-down-direction component, and a component against the change of the wheel alignment. The latter component can be regarded as a component against the external force that causes the wheel alignment change. Where the elastic reaction force of the main portion is divided into the two components described above, one of the two components influences the other of the two components since the main portion as a principal deformation subject is a single member. That is, when the lateral force or the like acts on the wheel and the component against the change of the wheel alignment changes, the up-down-direction component of the elastic reaction force also changes. By utilizing this phenomenon, the elastic reaction force of the loop spring can be changed so as to permit the vehicle body and the wheel to undergo the bound movement or the rebound movement when the lateral force acts on the wheel.

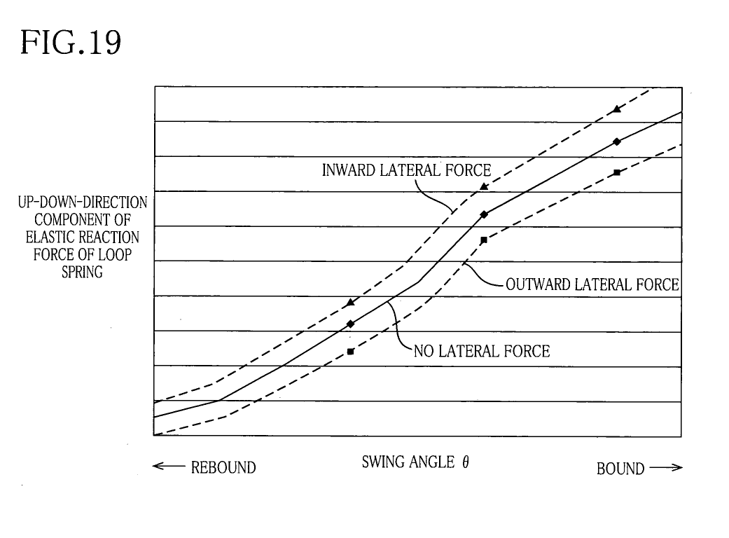

To be more specific, it is possible to realize a suspension apparatus in which the up-down-direction component of the elastic reaction force of the loop spring decreases when a force in a direction to cause the wheel to be moved away from the vehicle body in the vehicle width direction, i.e., an outward lateral force, acts on the wheel, whereas the up-down-direction component of the elastic reaction force increases when a force in a direction to cause the wheel to be moved toward the vehicle body in the vehicle width direction, i.e., an inward lateral force, acts on the wheel. In other words, in the suspension apparatus having a specific structure, it is possible to permit the vehicle body and the wheel to undergo the bound movement in accordance with the outward lateral force that acts on the wheel and to permit the vehicle body an the wheel to undergo the rebound movement in accordance with the inward lateral force that acts on the wheel. The up-down-direction component of the elastic reaction force of the loop spring in the suspension apparatus is shown in the graph of FIG. 19. The graph shows a shift of the up-down-direction component of the elastic reaction force when the lateral force with a certain magnitude acts on the wheel. The shift amount increases with an increase in the lateral force that acts on the wheel.

When the vehicle turns, the vehicle body rolls due to the centrifugal force that acts on the vehicle body. More specifically, the roll moment that arises from the centrifugal force acts on the vehicle body, and the ratio of the vehicle weight that should be shared by the left and the right wheels changes such that the shared load on the inner-wheel side with respect to the turning becomes small whereas the shared load on the outer-wheel side with respect to the turning becomes large. Owing to this, the wheel and the vehicle body undergo, from the neutral state, the rebound movement on the inner-wheel side while the wheel and the vehicle body undergo, from the neutral state, the bound movement on the outer-wheel side. As a result, the vehicle body rolls. In the meantime, the lateral force is applied to the wheel due to the turning of the vehicle. The lateral force acts as the outward force on the inner wheel with respect to the turning and as the inward force on the outer wheel with respect to the turning. Accordingly, in the suspension apparatus having the above-described specific structure, it is possible to decrease the up-down-direction component of the elastic reaction force of the loop spring on the inner-wheel side and to increase the up-down-direction component of the elastic reaction force of the loop spring on the outer-wheel side, thereby suppressing the rebound movement on the inner-wheel side and the bound movement on the outer-wheel side that arise from the roll moment. That is, it is possible to obtain an effect similar to that obtained when the vehicle is equipped with a stabilizer. Where this effect is called a stabilizer effect, the stabilizer effect can be obtained without the stabilizer.

In general, the stabilizer is constituted mainly by a torsion bar. The torsion bar connects the left and the right wheels and is twisted by a difference in the up-down movement between the left wheel and the right wheels so as to generate a roll restraining force having a magnitude that depends on the twisting. Where such a stabilizer is mounted on the vehicle, the vehicle body needs to be lifted up to a comparatively high position in installing the suspension system on the vehicle body due to a need to permit the vehicle body to hold the torsion bar. By employing the suspension apparatus having the above-described specific structure, however, the stabilizer effect can be obtained without the stabilizer, so that the installation operation of the suspension system on the vehicle can be simply carried out.

The suspension apparatus 2 according to the present embodiment can be constructed so as to obtain the above-described stabilizer effect. The elastic deformation of the main portion 40 of the loop spring 10 can be divided into the twisting deformation and the bending deformation, and the stabilizer effect highly depends on the twisting deformation. Accordingly, the suspension apparatus 2 may be constructed such that the twisting deformation is generated when the lateral force acts. In the suspension apparatus 2, however, the second carrier supporting portion 16 is disposed at the first attachment portion 42, and the first carrier supporting portion 14 is disposed at the boundary between the first section 46 and the second section 48 as explained above. Accordingly, the twisting deformation of the main portion 40 that relies on the displacements of the first carrier supporting portion 14 and the second carrier supporting portion 16 cannot be largely expected even when the lateral force acts on the wheel. Accordingly, the stabilizer effect is exhibited in the suspension apparatus 2 mainly on the basis of the twisting deformation of the main portion 40 caused by the inclination of the third carrier supporting portion 18, when the lateral force acts on the wheel. To be more specific, a desired stabilizer effect can be obtained by adjusting the position at which the third carrier supporting portion 18 is disposed, the position of the third carrier-support point SP3, etc. In this regard, the length of the third bracket 84 that constitutes the third carrier supporting portion 18 is a factor which influences the magnitude of the stabilizer effect. That is, where the length of the third bracket 84 is increased so as to increase a distance between the third carrier-support point SP3 and the neutral axis of the main portion 40, the main portion 40 undergoes large twisting deformation even when the same magnitude of the lateral force acts on the wheel, so that the stabilizer effect becomes large.

### MODIFIED EMBODIMENTS

In the suspension apparatus 2 according to the present embodiment, the two attachment portions are referred to as the first attachment portion 42 and the second attachment portion 44, respectively, and the rotation axes thereof are referred to as the first rotation axis R1 and the second rotation axis R2, respectively. The terms “the first” and “the second” are used for the sake of convenience for distinction of the constituent elements, and any of the two attachment portions may be referred to as the first attachment portion or the second attachment portion, and any of the two rotation axes may be referred to as the first rotation axis or the second rotation axis. In other words, a suspension apparatus according to an arrangement in which the first attachment portion 42 and the second attachment portion 44 are referred to vice versa and the first rotation axis and the second rotation axis are referred to vice versa can be one embodiment of the claimable invention. This is true of the first section 46 and the second section 48. Further, any of the three carrier supporting portions 14, 16, 18 may be referred to as the first carrier supporting portion, the second carrier supporting portion, or the third carrier supporting portion. In other words, a suspension apparatus according to an arrangement in which any of the first carrier supporting portion, the second carrier supporting portion, and the third carrier supporting portion is referred to another of those can be one embodiment of the claimable invention.

The suspension apparatus 2 described above is for the rear right wheel. The suspension apparatus for the rear left wheel may be constructed so as to be symmetrical relative to the suspension apparatus 2. A suspension apparatus for the front right wheel and a suspension apparatus for the front left wheel may be appropriately constructed according to the description in the FORMS OF THE INVENTION, for instance, by considering the change of the wheel alignment caused by the swinging of each loop spring, the stabilizer effect, and so on.

In the suspension apparatus 2 described above, the loop spring 10 has an annular shape as seen in the wheel-axis direction. A suspension apparatus in which the shape of the loop of the loop spring is changed into any of various shapes described in the explanation relating to the form (10) in the FORMS OF THE INVENTION can be one embodiment of the claimable invention. This is true of an instance in which the cross-sectional shape of the loop spring is changed and an instance in which the material of the loop spring is changed. While, in the suspension apparatus 2, the main portion 40 of the loop spring 10 is divided into the plurality of sections 46, 48, a suspension apparatus in which the main portion is constituted by a single elongate member, namely, a single section, can be one embodiment of the claimable invention.

In the suspension apparatus 2 described above, the two attachment portions 42, 44 are disposed so as to be close to each other in the wheel-axis direction and overlap each other as seen in the wheel-axis direction. Further, the rotation axes R1, R2 of the respective two attachment portions 42, 44 are located in the one plane that is parallel to the horizontal plane and intersect each other at the prescribed angle. It is just needed that the two attachment portions are disposed such that the respective rotation axes are mutually different, and a suspension apparatus in which the two attachment portions are disposed according to any of various disposition relationships described in the explanation relating to the form (1) in the FORMS OF THE INVENTION can be one embodiment of the claimable invention.

In the suspension apparatus 2 described above, the carrier 12 is supported by the plurality of carrier supporting portions 14, 16, 18. A suspension apparatus in which the carrier is supported by a single carrier supporting portion can be one embodiment of the claimable invention. In the suspension apparatus 2 described above, the first carrier supporting portion 14 supports the carrier 12 via the ball joint while the second and third carrier supporting portions 16, 18 support the carrier 12 via the respective rubber bushings. All of the plurality of carrier supporting portions may be configured to support the carrier 12 via the rubber bushings. In other words, all of the plurality of carrier supporting portions may be configured to support the carrier such that displacements of the respective carrier-support points respectively corresponding to the carrier supporting portions are allowed. Further, in the suspension apparatus 2, the carrier supporting portions 14, 16, 18 are constituted by the brackets 80, 82, 84, respectively, and the carrier supporting portions 14, 16, 18 support the carrier 12 such that the distal ends of the respective brackets 80, 82, 84 are located inside the loop of the loop spring 10. In place of such a structure, at least one of the plurality of carrier supporting portions may be configured such that the distal end of the bracket is located outside the loop of the loop spring.

The suspension apparatuses modified according to the description in the FORMS OF THE INVENTION and suspension apparatuses variously modified based on the knowledge of a person skilled in the art can be embodiments of the claimable invention though a detailed explanation thereof is not given.

1. A suspension apparatus for a vehicle, comprising:
a loop spring including: (A) a main portion having a shape obtained by forming an elongate member into a loop as seen in a wheel-axis direction in which an axis of a wheel extends; (B) a first attachment portion which is fixedly provided at one of opposite ends of the main portion and which is attached to a body of the vehicle so as to be rotatable about a first rotation axis; and (C) a second attachment portion which is fixedly provided at the other of the opposite ends of the main portion and which is attached to the body of the vehicle so as to be rotatable about a second rotation axis different from the first rotation axis; and
a carrier which is supported by the loop spring and which holds the wheel rotatably about the axis thereof,
wherein the suspension apparatus is configured to suspend the body of the vehicle based on an elastic reaction force of the main portion of the loop spring,
wherein the suspension apparatus further comprises a plurality of carrier supporting portions each of which is fixedly provided on the loop spring at a circumference thereof, and
wherein the carrier is supported by the plurality of carrier supporting portions.

2. The suspension apparatus according to claim 1, comprising three carrier supporting portions as the plurality of carrier supporting portions.

3. The suspension apparatus according claim 2,
wherein a disposition angle of each of the three carrier supporting portions with respect to a center of the loop of the loop spring is defined as a carrier-supporting-portion disposition angle, and
wherein the three carrier supporting portions are disposed at respective positions such that a difference in the carrier-supporting-portion disposition angle between any two of the three carrier supporting portions is not less than 90°.

4. The suspension apparatus according to claim 1,
wherein each of the plurality of carrier supporting portions is configured to support the carrier so as to permit a pivotal movement of the carrier relative to said each of the plurality of carrier supporting portions,
wherein a center point of a portion of the carrier that is supported by each of the plurality of carrier supporting portions is defined as a carrier-support point, and
wherein one of the plurality of carrier supporting portions supports the carrier so as to prohibit a displacement of the carrier-support point relative to the one of the plurality of carrier supporting portions while each of the remainder of the plurality of carrier supporting portions supports the carrier so as to permit a displacement of the carrier-support point relative to said each of the remainder of the plurality of carrier supporting portions.

5. The suspension apparatus according to claim 1,
wherein the elongate member by which the main portion of the loop spring is formed is divided into a first section and a second section in a circumferential direction of the loop of the loop spring, the first section having bending rigidity higher than that of the second section in an instance where the first section and the second section are bent in a vehicle width direction, and
wherein one of the plurality of carrier supporting portions is disposed at any one of (a) the first section and (b) a boundary between the first section and the second section while each of the remainder of the plurality of carrier supporting portions is disposed at a portion of the loop spring except (a) the first section and (b) the boundary.

6. The suspension apparatus according to claim 1, wherein one of the plurality of carrier supporting portions is disposed on one of the first attachment portion and the second attachment portion.

7. The suspension apparatus according to claim 1, wherein the carrier is disposed inside the loop of the loop spring, and the loop spring is disposed in a rim portion of a wheel body, a as seen in the wheel-axis direction.

8. The suspension apparatus according to claim 1, wherein the first rotation axis and the second rotation axis intersect each other and are located on one plane.

9. The suspension apparatus according to claim 1, wherein the first attachment portion and the second attachment portion overlap each other as seen in the wheel-axis direction.

10. The suspension apparatus according to claim 1, wherein one of the first rotation axis and the second rotation axis is parallel to the axis of the wheel.

11. The suspension apparatus according to claim 1, wherein the axis of the wheel and at least one of the first attachment portion and the second attachment portion are arranged so as to be parallel to a horizontal plane, in a state in which the vehicle equipped with the suspension apparatus is kept stationary on a flat and horizontal road surface.

12. The suspension apparatus according to claim 1, further comprising a spring support member which is fixed to the body of the vehicle and in which there are integrally formed (i) a first support shaft portion defining the first rotation axis and rotatably supporting the first attachment portion and (ii) a second support shaft portion defining the second rotation axis and rotatably supporting the second attachment portion,
wherein the first attachment portion and the second attachment portion are attached to the body of the vehicle via the spring support member.

13. The suspension apparatus according to claim 1, wherein the carrier supports a motor configured to drive the wheel, such that the motor is disposed inside the loop of the loop spring as seen in the wheel-axis direction.

14. The suspension apparatus according to claim 1, which is configured such that at least one of a toe angle and a camber angle, of the wheel, changes by a change in a posture of the carrier that is caused by a relative movement of the body of the vehicle and the wheel in an up-down direction.

15. The suspension apparatus according to claim 1, which is configured such that, where a lateral force acts on the wheel, the main portion of the loop spring is elastically deformed in accordance with a magnitude of the lateral force and the wheel and the body of the vehicle are moved relative to each other in an up-down direction by a reaction force resulting from the elastic deformation.
